(19) United States
(12) Patent Application Publication
(10) Pub. No.: US 2022/0400733 A1
(43) Pub. Date: Dec. 22, 2022

(54) EMULSIONS

(71) Applicant: Givaudan SA, VERNIER (CH)

(72) Inventors: Lena Lore HECHT, Wallisellen (CH); Rosa NAVARRO, Macul (CL); Juan Carlos GERMAIN, Talagante (CL); Kerry WARD-ROTHERHAM, Derbyshire (GB); Lisette Alejandra ESPINOZA OLAVE, Santiago (CL)

(21) Appl. No.: 17/774,881

(22) PCT Filed: Nov. 13, 2020
(86) PCT No.: PCT/EP2020/082055

§ 371 Date: May 6, 2022

(30) Foreign Application Priority Data
Nov. 14, 2019 (GB) 1916585.1

(51) Int. Cl. A23L 35/00; A23D 7/005; A23L 2/56; A23L 2/385; A23L 2/62; A23G 9/32; A23L 33/115; A23L 33/105

(52) U.S. Cl. CPC A23L 35/10; A23D 7/0056; A23L 2/56; A23L 2/385; A23L 2/62; A23G 9/327; A23L 33/115; A23L 33/105; A23V 2002/00

(57) ABSTRACT

Emulsions and concentrates are provided. The concentrates include oat oil, at least one polyol and/or native or modified carbohydrate, and at least one benefit agent. The oat oil includes 8 wt % or more of ceramides and glycolipids.

### FIELD OF THE INVENTION

The present disclosure relates to emulsions such as concentrates including oat oil, wherein the oat oil contains at least 8 wt.-% of ceramides and glycolipids. More particularly, the present disclosure relates to emulsified concentrates formed by emulsifying these concentrates, to a method of preparation of such concentrates and emulsified concentrates, and to food and beverage products comprising such emulsions, concentrates and emulsified concentrates.

### BACKGROUND OF THE INVENTION

Benefit agents, such as flavors, colorants and nutraceutical agents, including vitamins, carotenoids, and antioxidants are commonly incorporated in food in order to enhance their taste, pleasantness and nutritive quality for consumers.

A recurring issue encountered when incorporating these benefit agents in liquid or pasty food products is the difficulty to dose minute amounts of powerful flavor ingredients or highly colored dyes to the product, especially under production conditions. A second recurring issue concerns possible incompatibilities between the benefit agent and the food matrix, leading to lack of solubility and/or phase separation. Both issues often results in inhomogeneously flavored or inhomogeneously colored products.

On the other hand, nutraceutical agents may be degraded in the food matrix or in the stomach or gastro-intestinal tract, which may decrease its bioavailability post digestion.

A way to circumvent these issues is to supply the benefit agent in solid form, for example by spray drying or extruding the benefit agent combined with a water-soluble carrier material, for example a polysaccharide. Such solid forms are well-known to the art. However, this way to proceed may have some drawbacks. For example, incorporating a solid form in liquids or in pastes may be difficult, due to poor carrier solubility in said liquids and pastes.

Another way is to dilute the benefit agent in a solvent, such as an alcohol, a polyol or an oil. However, such dilutions may not be soluble in or compatible with the food matrix they are intended to be mixed to.

Another way is to supply the benefit agent in the form of an emulsion, obtained by emulsifying an oil phase in a polar phase, for example an oil-in-water emulsion. This way is particularly suitable in the case of aqueous products, such as beverages. Emulsions may be furthermore tailored to produce transparent to turbid beverages, depending on the type of beverages. However, producing storage- and dilution-stable emulsions often requires high levels of surfactants or emulsifiers, which often requires specific declarations on product labels. High levels of surfactants and emulsifiers may also alter the taste and texture of the beverages.

Hence, there remains a need for benefit agent delivering systems that do not suffer from the drawbacks mentioned hereinabove and, still, provide a homogeneous distribution of the benefit agent within liquid or pasty food products without altering the taste and texture of these products.

### SUMMARY OF THE INVENTION

In a first aspect, the invention relates to an emulsion (or emulsion of the invention), comprising
a. Oat oil, comprising 8 wt.-% or more of ceramides and glycolipids
b. optionally at least one polyol and/or a native or modified carbohydrate; and
c. optionally at least one benefit agent.

In particular embodiments, the emulsion of the invention further comprises one or more saponin(s) such as quillaja saponin(s).

In particular embodiments, the level of water is kept at low values, for example 20 wt.-% of water or less, based on the total weight of the emulsion.

Thus, the present invention is also related to a concentrate (or concentrate of the invention) comprising
a) Oat oil, comprising 8 wt.-% or more of ceramides and glycolipids
b) At least one polyol and/or a native or modified carbohydrate; and
c.) At least one benefit agent.

In particular embodiments, the concentrate additionally comprises at least one saponin such as quillaja saponin(s).

In particular embodiments, the emulsion or the concentrate of the invention is substantially free of added preservatives.

In particular embodiments, the emulsion or the concentrate additionally comprises a vegetable oil product, wherein the vegetable oil product is selected from the group consisting of crude vegetable oil, transformed vegetable oil, or a vegetable oil fraction and wherein the additional vegetable oil product is not derived from oat oil.

In one embodiment, the vegetable oil product is a vegetable oil fraction comprising medium chain triglycerides, more particularly C 8 to C 12 triglycerides.

In particular embodiments of the present disclosure, the concentrate is an emulsion comprising droplets of a dispersed phase and a continuous phase.

In particular embodiments, the dispersed phase essentially comprises the oil-soluble components of the emulsion and the continuous phase essentially comprises the oil-insoluble components of the emulsion in particular embodiments, the level of water is kept at low values, for example 20 wt.-% of water or less, based on the total weight of the concentrate.

In one embodiment the dispersed oil droplets of the emulsion may have a mean droplet diameter (such as z-average or volume-average mean D(4,3)) of from about 50 nm to about 20 micrometer, more particularly from about 50 nm to about 800 nm, or from about 50 nm to about 199 nm, or from about 200 nm to about 400 nm, or from about 300 nm to about 800 nm, or from about 0.5 micrometer to 2 micrometer, or from 2.5 micrometer to 10 micrometer. In one embodiment, the diameter is 70 nm, or 120 nm or 130 nm.

In the present invention the droplet size is defined as droplet diameter, and both terms can be interchangeable.

In another aspect, the present disclosure provides a method to obtain the concentrate of the invention by performing the steps of:
a. Mixing the oat oil, at least one benefit agent and optionally the vegetable oil product, in order to form a mix;
b. Adding this mix to at least one polyol, optionally comprising water;
c. Optionally adding a saponin(s); and
d. Applying low shear mixing to obtain a concentrate.

In particular embodiments, the method additionally comprises the step of.

Applying high energy emulsification methods or low energy emulsification methods to the concentrate in order to form an emulsified concentrate.

In another embodiment in regard to step d) the polar and lipid phase are mixed together directly via a low energy emulsification step (such as membrane emulsification).

In another aspect, the present invention provides a food or beverage product for humans or animals, a nutritional supplement, a nutraceutical formulation, a fragrance or flavouring, a pharmaceutical or veterinary formulation or an oenological or cosmetic formulation comprising an emulsion or concentrate of the invention.

In particular embodiments, the food or beverage product is a transparent or hazy product having a turbidity of less than about 35 NTU, more particularly less than about 20 NTU, still more particularly less than about 10 NTU, or a haze value of less than about 25%, or less than about 20%, more particularly less than about 15%, still more particularly less than about 10%; or is a cloudy food or beverage product having a turbidity higher than about 35 NTU, more particularly higher than about 300 NTU, for example between about 300 and about 500 NTU.

In another aspect, the present disclosure provides the use of the emulsion or the concentrate according to the present disclosure to obtain food and beverage products having a turbidity of less than about 35 NTU, more particularly less than about 20 NTU, still more particularly less than about 10 NTU, or a haze value of less than about 25%, or less than about 20%, more particularly less than about 15%, still more particularly less than about 10%; or is a cloudy food or beverage product having a turbidity higher than about 35 NTU, more particularly higher than about 300 NTU, for example between about 300 and about 500 NTU.

In another aspect, the present invention provides the use of an emulsion of the invention or a concentrate emulsion of the invention to increase the bioaccessibility, bioavailability, bioefficacy and/or bioactivity of an active or benefit agent.

In another aspect, the present invention provides a method for improving bioaccessibility, bioavailability, bioefficacy and/or bioactivity of a benefit agent in humans or animals, comprising the administration of said benefit agent in the form of a composition comprising (i) an emulsion or a concentrate of the invention, (ii) optionally at least one saponin (such as quillaja saponin) as emulsifiers and (iii) a benefit agent.

### DETAILED DESCRIPTION OF THE INVENTION

The applicant has discovered that by mixing oat oil, polyols and benefit agent, a concentrate could be obtained that surprisingly could form stable emulsions, in the absence of any additional surfactant or emulsifier.

The applicant has also discovered that emulsions formed with oat oils and saponins could form stable emulsions when subjected to dispersive shear forces. The inventors of the present invention have shown that the emulsions of the invention have a better instant solubility and less foaming in beverages when compared with emulsions based on commonly used emulsifiers such as polysorbate 80. Also the emulsions of the invention have an increased stability at higher storage temperatures (for example at 40° C.) when compared with emulsions based on commonly used emulsifiers such as polysorbate and sorbitan monoleate. Additionally, when diluted, the emulsions of the invention can form very clear solutions without a ringing in acidic conditions.

By “high energy emulsification” is meant emulsification applied by means of a rotor-stator mixer, a high-pressure homogenizer or ultra-sonication.

By “low energy emulsification” is meant emulsification applied by means of a low pressure homogenizer, like membrane emulsification or microfluidic emulsification.

By “stable emulsion” is meant an emulsion that does not phase separate over a prolonged period of time when subjected to storage test conditions, such as one day, or 2, 3, 4, 5, 6, or 7 days, or 2 weeks, or 3 weeks, or 1 month, or 2 months, or 3 months at for example 20° C. and/or at 40° C. The terms “emulsion” and “emulsified concentrate” are considered as equivalent in the context of this disclosure.

The present application is thus related to an emulsion (or emulsion of the invention) comprising
a. Oat oil, comprising 8 wt.-% or more of ceramides and glycolipids
b. at least one polyol and/or a native or modified carbohydrate; and
c. at least one benefit agent.

In one embodiment, the emulsion of the invention may comprise optionally at least one polyol and/or a native or modified carbohydrate; and optionally at least one benefit agent.

The present application is also related to an emulsion (or emulsion of the invention) comprising
a. Oat oil, comprising 4 wt.-% or more of polar lipids
b. optionally at least one polyol and/or a native or modified carbohydrate; and
c. optionally at least one benefit agent.

As used herein, the term “oat oil” may refer to one type of oat oil or a combination of the different oat oils described herein. Thus the term “oat oil” and “oat oils” are interchangeable in the present text. Therefore, the emulsions or concentrates of the invention may comprise one or more oat oils.

Oat oil may be used as crude oil or refined oil. In one embodiment, oat oil fractions having enriched levels of glycolipids and ceramides are used. In one embodiment, the level of glycolipids and ceramides is higher than 9 wt.-%, or higher than 10 wt.-%, or higher than 12 wt.-%, or higher than 13 wt.-%, higher than 14 wt.-%, or higher than 15 wt.-%, or higher than 20 wt.-%, or higher than 25 wt.-% based on the total weight of the oat oil.

In one embodiment, at least 4%, or at least 10%, or at least 11%, or at least 12%, or at least 13%, or at least 14%, or at least 15%, or at least 16%, or at least 17%, or at least 18%, or at least 19%, or at least 20%, or at least 22%, or at least 23%, or at least 24%, or at least 25%, or at least 26%, or at least 27%, or at least 28%, or at least 29%, or at least 30%, or at least 31%, or at least 33%, or at least 35%, or at least 40% by weight of the oat oil are polar lipids.

The polar lipid fraction of the oat oils may comprise one or more ceramides, glycolipids (such as digalactosyldiacylglycerol, monogalactosyldiacylglycerol, monogalactosylmonoglyceride, and other glycolipids), phosphatidylethanolamine, phosphatidylinositol, phosphatidylserine, phosphatidylcholine, lysophosphatidylcholine, etc.

In particular embodiments, the polar oat oil fraction comprises at least 3 wt.-%, in another embodiment at least 4 wt.-%, for example at least 4.5 wt.-%, at least 5 wt.-%, or at least 6 wt.-% of ceramides, based on the total weight of the oil fraction.

In particular embodiments, the ceramides comprised in the polar oat oil fraction include glucosyl ceramides, glucosyl hydroxyceramides, glycosylinositophosphoceramides, glycosylinositophosphohydroxy-ceramides, and/or hydroxyceramides.

In particular embodiments, the polar oat oil phase comprises at least 5 wt.-%, at least 6 wt.-%, at least 7 wt.-%, at least 8 wt.-%, at least 9 wt.-% for example at least 10 wt.-%, at least 11 wt.-% or at least 12 wt.-%, at least 15 wt.-%, at least 20 wt.-%, at least 25 wt.-%, at least 30 wt.-%, at least 35 wt.-% of galactosyl acyl glycerols, based on the total weight of the oil fraction. Preferably at least 4, 5, 6, 7, 8, 9, 10, 11, 12, 13, 15, 20, 25, 30, 35, 40, 45, 50, 55 or 60 wt % of the polar lipids are glycolipids, and more preferably galactosyl acyl glycerols in particular embodiments the galactosyl acyl glycerols comprised in the polar oat fraction include at least one of monogalacosyldiacylglycerols and digalactosyldiacylglycerols.

Preferably at least 5, 10, 15, 20 or 25 wt % of the polar lipids are digalactosyldiacylglycerols.

Preferably the oat oil comprises 1, 2, 3, 4, 5, 6, 7, 8, 9, 10, 11, 12, 13, 15, 20, 25, 30, 35, 40, 45, 50, 55 or 60 wt % or more of ceramides by weight of the total oat oil.

Preferably the oat oil comprises 1, 2, 3, 4, 5, 6, 7, 8, 9, 10, 11, 12, 13, 15, 20, 25, 30, 35, 40, 45, 50, 55 or 60 wt % or more of glycolipids by weight of the total oat oil.

In another embodiment, at least 4%, at least 10%, at least 15%, at least 35% or at least 40% by weight of the oat oil lipids are polar lipids and the oat oil comprises 8 wt % or more of ceramides and glycolipids by weight of the total oat oil.

The polar lipids may also comprise phospholipids.

Preferably at least 4, 5, 6, 7, 8, 9, 10, 11, 12, 13, 15, 20, 25, 30, 35, 40, 45, 50, 55 or 60 wt % of the polar lipids are ceramides. In one embodiment, less than 85, 80, 60, 40, 20, 15, 10, 8, 6, 4 or 2 wt % of the polar lipids are phospholipids.

Preferably the polar lipids comprise at least 15 wt % phospholipids. In one embodiment, the polar lipids comprise at least 15, 16, 17, 18, 19 or 20 wt % phospholipids.

For example, the polar lipids may comprise 15 to 85 wt % phospholipids or 20 to 80 wt % phospholipids.

In one embodiment the lipids may comprise glycolipids and phospholipids at a weight ratio of at least 1:5 glycolipids to phospholipids, for example at least 1:4, at least 1:3, at least 1:2 or at least 1:1.5. The lipids may comprise glycolipids and phospholipids at a weight ratio of 1.5 to 3:1, for example about 1:4 to 2:1 or 1:3 to 1:1.

Examples of oat oils that can be used in the invention are the following oat oils: SWEOAT Oil PL4, SWEOAT Oil PL15 or SWEOAT Oil PL40.

SWEOAT Oil PL4 comprises the following per 100 grams: Fat 99 g, comprising 4 g of polar lipids and 95 g of neutral lipids; saturated fatty acids 17 g; monounsaturated fatty acids 37 g, polyunsaturated fatty acids 45 g.

SWEOAT Oil PL15 comprises the following per 100 grams: Fat 97 g, comprising 15 g of polar lipids and 82 g of neutral lipids; saturated fatty acids 17 g; monounsaturated fatty acids 37 g, polyunsaturated fatty acids 45 g, ceramides 4.5 g, glycolipids 12 g.

SWEOAT Oil PL40 comprises the following per 100 grams: Fat 98 g, comprising 40 g of polar lipids and 58 g of neutral lipids, between 4 and 6 g of ceramides, between 15.9 and 20 g of glycolipids.

In one embodiment, oat oil may comprise the following per 100 grams: Fat 97 to 99 g, comprising 4 to 40 g of polar lipids, 58 to 95 g of neutral lipids.

In one embodiment, oat oil may comprise the following per 100 grams: Fat 97 to 99 g, comprising 16 to 40 g of polar lipids, 58 to 83 g of neutral lipids and from 8 to 26 g of ceramides and glycolipids.

The emulsions of the invention can be incorporated to a food product or the emulsions can form the final food product (such as vegetable milks or creamers)

In one embodiment, preferably at least 0.005 wt % of the lipids in the food product are polar lipids.

In one embodiment, at least 0.01 wt %, at least 0.05 wt %, at least 0.1 wt %, at least 1.0 wt %, at least 2.0 wt % or at least 3.0 wt % of the lipids in the food product are polar lipids.

In one embodiment, 0.005 to 15 wt % of the lipids in the food product are polar lipids.

For example, 0.01 to 15 wt %, 0.05 to 15 wt %, 0.1 to 15 wt %, 0.5 to 15 wt %, 1 to 15 wt %, 2 to 15 wt %, 0.01 to 12 wt %/o, 0.05 to 12 wt %, 0.1 to 12 wt %, 0.5 to 12 wt %, 1 to 12 wt %, 2 to 12 wt %, 0.01 to 10 wt %, 0.05 to 10 wt %, 0.1 to 10 wt %, 0.5 to 10 wt %, 1 to 10 wt %, 2 to 10 wt %, 0.01 to 8 wt %, 0.05 to 8 wt %, 0.1 to 8 wt %, 0.5 to 8 wt %, 1 to 8 wt %, or 0.2 to 8 wt % of the lipids in said food product may be polar lipids.

In a preferred embodiment, the emulsion further comprises at least one saponin.

The saponin may be selected from the group consisting of quillaja saponins, tea saponins, licorice saponins, beet root saponins, fenugreek saponin, alfalfa saponin, fennel saponin, garlic saponin, asparagus saponin, quinoa saponin, sugar beet saponins, ginseng saponins, glycyrrhizin, oat bran saponins, and yucca saponins or mixtures thereof.

The saponin concentration is from 0.05 wt.-% to 20 wt.-%, or from 0.2 wt.-% to 7 wt.-%, or from 0.5 wt.-% to 7 wt.-%, such as from 1 to 4 wt.-% of the total emulsion. In one embodiment the saponin concentration is from 1.5 wt.-% to 3.7 wt.-%, such as 1.5 or 2 wt.-%. In another embodiment the concentration of saponin is from about 0.075 wt.-% (for example for applications like margarines). In another embodiment, the concentration of saponin is from 2 to 3 wt.-% (for example when the benefit agent is a flavor).

The inventors have surprisingly shown that oat oils and saponins can stabilize emulsions such as water-in-oil emulsions and oil-in-water emulsions. For example the inventors have successfully produced margarine with small droplets. (see example 12).

The ratio between saponins and oat oils may be from about 0.01:1 to about 10:1, more particularly from 0.1:1 to 2:1 or 0.02:1 to 0.05:1.

The ratio between saponins and polar lipids may be from about 0.1:1 to about 25:1, more particularly from 0.5:1 to 5:1 or 0.2:1 to 0.5:1.

In one embodiment the ration between the saponin and oat oil may be about 1:1.6 or 1:0.67.

The ration between saponins and polar lipids may be from: 0.02:04 to 5:4, such as 0.1:2, or such as about 0.2:1.5 or about 0.4:1 The emulsions of the invention may comprise 95 wt.-% or less of water, or 80 wt.-% or less, or 70 wt.-% or less, or 60 wt.-% or less, or 50 wt.-% or less, or 40 wt.-% or less, or 30 wt.-% or less, or 20 wt.-% or less of water, such as 10 wt.-% or less of water.

In one embodiment, the emulsion can be presented as a concentrate.

The emulsions of the invention may be prepared by a process comprising:
a) mixing ingredients of an aqueous phase;
b) mixing ingredients of a lipid phase,
c) dispersing oat oil and optionally at least one saponin (such as quillaja saponin) in one or both of the aqueous phase or the lipid phase; and
d) homogenizing the two phases to form an emulsion.

In a preferred embodiment at least one saponin (such as quillaja saponin) is also added.

In step a) the aqueous phase is prepared by mixing all ingredients that may be part of the emulsion that are essentially soluble in water.

In step b) the lipid phase is prepared by mixing all ingredients that may be part of the emulsion (such as the benefit agents, lipid soluble colors, etc) that are essentially soluble in lipids.

In step c) the oat oils may be dispersed in one or both of the aqueous phase or the lipid phase. If the emulsion also comprises at least one saponin (such as quillaja saponins), the oat oils and the saponins may be dispersed in one or both of the aqueous phase or the lipid phase.

In a preferred embodiment, the oat oils are dispersed in the lipid phase.

In another embodiment, the at least one saponin (such as quillaja saponin) is dispersed in the aqueous phase.

In another embodiment, oat oils and the at least one saponin are provided together (both emulsifiers are mixed and then dispersed in one or both of the above mentioned phases) In another embodiment, oat oils and the at least one saponin are provided separately (such as parts of a kit) and the oat oil is mixed to the lipid phase and the saponin is mixed to the aqueous phase.

In step d) the homogenization process may comprise applying high or low energy emulsification methods to the mixture obtained in c) in order to obtain an emulsion.

In regard to step d, the emulsion may be obtained by applying first applying first a pre-emulsification step for example by using a propeller, a blade, or a tooth-rimmed dispersion system.

In another embodiment in regard to step d) the polar and lipid phase are mixed together directly during the low energy emulsification step.

Optionally or additionally, the emulsion may be emulsified by using a high pressure homogenizer. The composition may be homogenized with high pressure homogenization by passing said composition one or more time through a valve. In general the pressure applied is about 10 to 150 MPa or from about to 20 to 100 MPa (which includes a range from about 30-100 MPa, such as 35 or 40 MPa) such as 95 mPa. The number of times the composition passes through the valve may be 1 to 10 times, (which included 2-5, e.g. 3 times). In case that two-stage homogenization is used, the composition is passed through two valves, wherein the pressure in the second valve is set to about 3-50% (e.g. 10-30%, including 25%, such as 3%) of the pressure in the first valve. The emulsion is homogenized for 1-10 passes through the two valves (which included 2-5, e.g. 3 passes). Optionally, a cooling step in between passes may be applied, in particular when the temperature of the emulsion exceeds 40° C., which otherwise may impact the content and quality of the benefit agent.

The dispersed oil droplets of the emulsion formed using oat oils may have a mean droplet diameter (such as z-average or volume-average mean D(4,3)) of from about 50 nm to about 20 micrometer, more particularly from about 50 nm to about 800 nm, or from about 50 nm to about 199 nm, or from about 200 nm to about 400 nm, or from about 300 nm to about 800 nm.

The dispersed oil droplets of the emulsion formed using oat oils and at least one saponin may have a mean droplet diameters (such as z-average or volume-average mean D(4,3) of from about 50 nm to about 20 micrometer, more particularly from about 50 nm to about 800 nm, or from about 50 nm to about 199 nm, or from about 200 nm to about 400 nm, or from about 300 nm to about 800 nm, or from about 0.5 micrometer to 2 micrometer, or from 2.5 micrometer to 10 micrometer. In one embodiment, the diameter is 70 nm, or 120 nm or 130 nm.

In one embodiment, the emulsion is water in oil emulsion (such as margarine) and the droplet diameter is from about 2.5 micrometer to about 20 micrometer, more preferred from 2.5 micrometer to 10 micrometer.

The present invention is also related to the use of oat oil(s) and at least one saponin for use as emulsifying agents.

The oat oils have been described previously.

The emulsions of the invention can be incorporated to a food product or the emulsions of the invention can form the final food product (such as vegetable milks or creamers)

The emulsions of the invention can be formulated as concentrates. Example number 11 shows different examples of emulsions of the invention in form or a concentrate wherein the benefit agent (colour) has being incorporated into the emulsion. The inventors of the present invention have shown that the emulsions of the invention have a better instant solubility and less foaming in beverage when compared with emulsions based on commonly used emulsifiers such as polysorbate 80. Also the concentrates of the invention have an increased stability of the liquid emulsion at higher storage temperatures (for example at 40° C.) when compared with emulsions based on commonly used emulsifiers such as polysorbate and sorbitan monoleate. Additionally the concentrates of the invention can form very clear solutions without a ringing in acidic conditions.

Thus, the present invention is related to a concentrate comprising
a. Oat oil, comprising 8 wt.-% or more of ceramides and glycolipids
b. At least one polyol and/or a native or modified carbohydrate; and
c. At least one benefit agent.

The concentrate of the invention may be presented as such (without being emulsified) or can be subjected to shear forces to obtain an emulsified concentrate (or concentrate emulsion of the invention).

Oat oil may be used as crude oil or refined oil. In one embodiment, oat oil fractions having enriched levels of glycolipids and ceramides are used. In one embodiment, the level of glycolipids and ceramides is higher than 9 wt.-%, or higher than 10 wt.-%, or higher than 12 wt.-%, or higher than 13 wt.-%, higher than 14 wt.-%, or higher than 15 wt.-%, in another embodiment higher than 20 wt.-%, in another embodiment higher than 25 wt.-%.

Such oat oil fractions are referred to as polar oat oil fractions hereinafter.

In one embodiment, at least 10%, or at least 11%, or at least 12%, or at least 13%, or at least 14%, or at least 15%, or at least 16%, or at least 17%, or at least 18%, or at least 19%, or at least 20%, or at least 22%, or at least 23%, or at least 24%, or at least 25%, or at least 26%, or at least 27%, or at least 28%, or at least 29%, or at least 30%, or at least 31%, or at least 33%, or at least 35%, or at least 40% by weight of the oat oil are polar lipids.

The polar lipid fraction of the oat oils may comprise one or more ceramides, glycolipids (such as digalactosyldiacylglycerols, monogalactosyldiacylglycerol, monogalactosylmonoglyceride, and other glycolipids), phosphatidylethanolamine, phosphatidylinositol, phosphatidylserine, phosphatidylcholine, lysophosphatidylcholine, etc.

In particular embodiments, the polar oat oil fraction comprises at least 3 wt.-%, in another embodiment at least 4 wt.-%, for example at least 4.5 wt.-%, at least 5 wt.-%, or at least 6 wt.-% of ceramides, based on the total weight of the oil fraction.

In particular embodiments, the ceramides comprised in the polar oat oil fraction include glucosyl ceramides, glucosyl hydroxyceramides, glycosylinositophosphoceramides, glycosylinositophosphohydroxy-ceramides, and/or hydroxyceramides.

In particular embodiments, the polar oat oil phase comprises at least 5 wt.-%, at least 6 wt.-%, at least 7 wt.-%, at least 8 wt.-%, at least 9 wt.-% for example at least 10 wt.-%, at least 11 wt.-% or at least 12 wt.-%, at least 15 wt.-%, at least 20 wt.-%, at least 25 wt.-%, at least 30 wt.-%, at least 35 wt.-% of galactosyl acyl glycerols, based on the total weight of the oil fraction. Preferably at least 4, 5, 6, 7, 8, 9, 10, 11, 12, 13, 15, 20, 25, 30, 35, 40, 45, 50, 55 or 60 wt % of the polar lipids are glycolipids, and more preferably galactosyl acyl-glycerols.

In particular embodiments the galactosyl acyl glycerols comprised in the polar oat fraction include at least one of monogalactosyldiacylglycerols and digalactosyldiacylglycerols.

Preferably at least 5, 10, 15, 20 or 25 wt % of the polar lipids are digalactosyldiacylglycerides.

Preferably the oat oil comprises 1, 2, 3, 4, 5, 6, 7, 8, 9, 10, 11, 12, 13, 15, 20, 25, 30, 35, 40, 45, 50, 55 or 60 wt % or more of ceramides by weight of the total oat oil.

Preferably the oat oil comprises 1, 2, 3, 4, 5, 6, 7, 8, 9, 10, 11, 12, 13, 15, 20, 25, 30, 35, 40, 45, 50, 55 or 60 wt % or more of glycolipids by weight of the total oat oil.

In another embodiment, at least 10%, at least 15%, at least 35% or at least 40% by weight of the oat oil lipids are polar lipids and the oat oil comprises 8 wt % or more of ceramides and glycolipids by weight of the total oat oil.

The polar lipids may also comprise phospholipids.

Preferably at least 4, 5, 6, 7, 8, 9, 10, 11, 12, 13, 15, 20, 25, 30, 35, 40, 45, 50, 55 or 60 wt % of the polar lipids are ceramides.

In one embodiment, less than 85, 80, 60, 40, 20, 15, 10, 8, 6, 4 or 2 wt % of the polar lipids are phospholipids.

Preferably the polar lipids comprise at least 15 wt % phospholipids. In one embodiment, the polar lipids comprise at least 15, 16, 17, 18, 19 or 20 wt % phospholipids.

For example, the polar lipids may comprise 15 to 85 wt % phospholipids or 20 to 80 wt % phospholipids.

In one embodiment the lipids may comprise glycolipids and phospholipids at a weight ratio of at least 1:5 glycolipids to phospholipids, for example at least 1:4, at least 1:3, at least 1:2 or at least 1:1.5. The lipids may comprise glycolipids and phospholipids at a weight ratio of 1:5 to 3:1, for example about 1:4 to 2:1 or 1:3 to 1:1.

Examples of oat oils that can be used in the invention are the following oat oils: SWEOAT Oil PL15 or SWEOAT Oil PL40.

SWEOAT Oil PL15 comprises the following per 100 grams: Fat 97 g, comprising 15 g of polar lipids and 82 g of neutral lipids; saturated fatty acids 17 g; monounsaturated fatty acids 37 g; polyunsaturated fatty acids 45 g, ceramides 4.5 g, glycolipids 12 g.

SWEOAT Oil PL40 comprises the following per 100 grams: Fat 98 g, comprising 40 g of polar lipids and 58 g of neutral lipids, between 4 and 6 g of ceramides, between 15.9 and 20 g of glycolipids.

In one embodiment, oat oil may comprise the following per 100 grams: Fat 97 to 99 g, comprising 10 to 40 g of polar lipids, 58 to 89 g of neutral lipids and from 8 to 26 g of ceramides and glycolipids.

In particular embodiments of the present disclosure, the concentrate or concentrate emulsion of the invention additionally comprises at least one saponin.

In one embodiment the at least one saponin is selected from the group consisting of quillaja saponins, tea saponins, licorice saponins, beet root saponins, sugar beet saponins, ginseng saponins, glycyrrhizin, asparagus saponin, oat bran saponins, and yucca saponins or mixtures thereof.

In particular embodiments of the present disclosure, the concentrate additionally comprises an extract of quillaja.

According to one embodiment, the level of the at least one saponin is from 0.05 wt.-% to 20 wt.-%, or from 0.2 wt.-% to 7 wt.-%, or from 0.5 wt.-% to 7 wt.-%, such as from 1 to 4 wt.-%, based on the total weight of the concentrate.

The ratio between saponins and oat oils may be from about 0.01:1 to about 10:1, more particularly from 0.1:1 to 2:1 or 0.02:1 to 0.05:1.

The ratio between saponins and polar lipids may be from about 0.1:1 to about 25:1, more particularly from 0.5:1 to 5:1 or 0.2:1 to 0.5:1.

Below 8 wt.-% glycolipids and ceramides, the emulsifying power of oat oil is insufficient and the concentrate cannot be emulsified to form stable emulsions.

In one embodiment, the level of polar oat oil fraction in the concentrate is from 0.5 to 25 wt.-%, in another embodiment from 1 to 15 wt.-%, in yet another embodiment from 1.5 to 10 wt.-%, based on the total weight of the concentrate.

The applicant also found that the aforementioned emulsions of the invention, or emulsified concentrates (concentrates of the invention), could be used to produce stable cloudy food and beverage products.

By “cloudy food or beverage product” is meant a product that scatters the light in such a way that the human eye cannot see through it.

Furthermore, the applicant has found that concentrates additionally comprising at least one saponin could form emulsions that could be used to produce stable transparent to hazy food and beverage products, meaning products and beverages having a turbidity of less than 35 NTU, or of less than 25% NTU, more particularly less than 20 NTU, still more particularly less than 15% NTU, still more particularly less than 10% NTU, or a haze value of less than 20%, more particularly less than 15%, still more particularly less than 10%.

By “transparent food or beverage product” is meant a product that is as clear as water.

By “hazy food or beverage product” is meant a product that scatters the light in such a way that the human eye can see through it. Hazy food and beverage products may look bluish when observed at an angle of 90° with respect to the incoming light direction and yellowish when observed facing the incoming light.

The emulsion of the invention and the concentrate of the invention (or concentrate emulsion of the invention) may comprise components that are essentially soluble in oil and components that are essentially insoluble in oil. By “essentially soluble” is meant that, typically, more than 90 wt.-% of these essentially oil-soluble components are forming an oil phase. Similarly, by “essentially insoluble in oil”, is meant that, typically, more than 90 wt.-% of these essentially oil-insoluble components are forming a polar phase.

In particular embodiments, the polar phase may be in the form of a dispersion of droplets in the oil phase, forming thereby a polar phase-in oil emulsion or in the form of a continuous phase in which the oil phase is dispersed in the form of dispersed droplets, forming thereby an oil-in-polar phase emulsion.

In a particular embodiment, the dispersed oil droplets have a mean droplet diameters (such as z-average or D(4,3) of from about 50 nm to about 20 micrometer, more particularly from about 50 nm to about 800 nm, or from about 50 nm to about 199 nm, or from about 200 nm to about 400 nm, or from about 300 nm to about 800 nm, or from about 0.5 micrometer to 2 micrometer, or from 2.5 micrometer to 10 micrometer. In one embodiment, the diameter is 70 nm, or 120 nm or 130 nm.

The inventors of the present invention have demonstrated for example in example 10, that the emulsions of the present invention based on oat oils and quillaja as emulsifier agents, are very stable at acidic conditions (such as acidic beverages or food products)

In one embodiment, the emulsion of the invention or the concentrate or concentrate emulsion of the invention has a pH of less than 8, or less than 7, less than 6, less than 5, less than 4, less than 3, or less than 2 In another embodiment, the emulsion of the invention or the concentrate or concentrate emulsion of the invention may have a pH of 8 or more, such as 9, or 10.

In the case that the concentrate of the invention is added to a food product or beverage, in one embodiment, said food product or beverage may have a pH of less than 8, or less than 7, less than 6, less than 5, less than 4, less than 3, or less than 2. In another embodiment, said food product or beverage may have a pH of 8 or more, such as 9, or 10.

Food and beverage products comprising emulsions having a Z-average diameter or a volume-average mean D(4,3) of about 50 to about 199 nm are transparent to hazy, whereas food and beverage products comprising emulsions having dispersed oil droplets having a Z-average diameter or a volume-average mean D(4,3) of about 200 nm or larger are cloudy.

In one embodiment, for transparent food and beverages products, the Z-average diameter or the volume-average mean D(4,3) of the droplets is lower than about 150 nm, in another embodiment lower than about 130 nm.

The emulsions of the present invention and the concentrates or concentrate emulsions of the invention may also comprise polyols and for native or a modified carbohydrate.

Polyols that are particularly suitable for the sake of the present disclosure include 1,2-propylene glycol (DL-1,2-propanediol), 1,3-propane diol, glycerol, erythritol, sugar alcohols and mixture thereof. The at least one polyol may form a polar phase coexisting with the oil phase. The at least one polyol may also partition between the polar phase and the oil phase, so that part of the at least one polyol may be present in the oil phase.

In one embodiment, the level of the at least one polyol is from 0 to 85 wt.-%, such as 5 to 85 wt.-%, based on the total weight of the emulsion of the invention, the concentrate of the invention, or the concentrate emulsion of the invention, in another embodiment from 25 to 80 wt.-%, in yet another embodiment from 50 to 75 wt.-%, based on the total weight of the emulsion or concentrate.

The at least one polyol may be used alone or admixed with water, particularly drinkable water. However, in some embodiments, the level of water is kept at a low value.

In one embodiment, the level of water in the concentrate of the invention or the concentrate emulsion of the invention is 20 wt.-% or less, in another embodiment 10 wt.-% or less, based on the total weight of the concentrate. Low water contents make the concentrate more resistant to biological contamination, so that the addition of preservatives, such as potassium sorbate and/or sodium benzoate, may be not required. Consequently, it is not necessary to maintain acidic conditions in the concentrate, which are otherwise necessary for these preservatives to be active. The fact that acidification is not needed may have a beneficial impact on the stability of the benefit agent.

Hence, in particular embodiments, the emulsion of the invention or the concentrate of the invention is substantially free of added preservatives.

By substantially free of added preservatives is meant that the emulsion of the invention or the concentrate of the invention comprises less than 1 wt.-%, more particularly less than 0.5 wt.-%, still more particularly less than 0.1 wt.-% of the emulsion of the invention or the concentrate of the invention.

The emulsions of the present invention and the concentrates or concentrate emulsions of the invention may also comprise native or a modified carbohydrate.

In alternative embodiments of the present disclosure, the polyol is replaced by a native or a modified carbohydrate, more particularly by a polymeric carbohydrate. Such a replacement is particularly suitable in cases the concentrate is further processed in order to provide a solid form, more particularly a powder, a granulate or an extrudate.

Native polymeric carbohydrates that are particularly suitable for the sake of these alternative embodiments include starch, gum Arabic, and pectins. Modified polymeric carbohydrates that are particularly suitable for the sake of these alternative embodiments include dextrins, maltodextrins, and starch octenyl succinate.

In one embodiment, the level of the at least one native or modified carbohydrate is from 0.05 to 85 wt.-%, such as 5 to 85 wt.-%, based on the total weight of the emulsion of the invention, the concentrate of the invention, or the concentrate emulsion of the invention, in another embodiment from 25 to 80 wt.-%, in yet another embodiment from 50 to 75 wt.-%, based on the total weight of the emulsion or concentrate.

The emulsions of the present invention and the concentrates or concentrate emulsions of the invention may also comprise a benefit agent.

In particular embodiments of the present disclosure, the benefit agent may be selected from the group consisting of flavor ingredients, colorants, nutraceuticals or combinations thereof.

As used herein, a “colorant” is any substance that imparts colour by absorbing or scattering light at different wavelengths or modified the colour of the food product. A “food-grade colorant” refers to a colorant suitable for use in a food product intended for human or animal consumption, and is differentiated from a nontoxic material that may provide colour, but is generally not included in a food product or is only included in a trace amount. The term, “natural colorant,” includes colorants that exist in or are produced by nature or are sourced therefrom. In on preferred embodiment, the colorant is a lipid soluble colorant.

In particular embodiments of the present disclosure the benefit agent is at least one flavor ingredient selected from the group consisting of 1,1-diethoxyethane; 3-hydroxybutan-2-one; 1-phenylethanone; (Z)-oxacycloheptadec-10-en-2-one; benzaldehyde; Bergamot oil; 2-methylpropyl acetate; 2-methylpropyl 2-methylbutanoate; butanal; butyric acid; 2-methylpropanoic acid; 2-methyl-5-prop-1-en-2-ylcyclohex-2-en-1-ol; (2E)-3-phenylprop-2-enal; cinnamon oil leaf: (E)-3,7-dimethylocta-2,6-dienal; 3,7-dimethyloct-6-enal; 3,7-dimethyloct-6-en-1-ol; (E)-1-(2,6,6-trimethylcyclohexa-1,3-dien-1-yl)but-2-en-1-one: 6-pentyltetrahydro-2H-pyran-2-one; 5-hexyloxolan-2-one; decanal; chroman-2-one; methyl 2-(methylamino)benzoate; dimethyl sulfide; oxydibenzene; 1-methyl-4-prop-1-en-2-ylcyclohexene, 5-octyloxolan-2-one; ethyl acetate; ethyl butanoate; ethyl 2-methylpropionate; ethyl 3-phenylprop-2-enoate; ethyl decanoate; 6-ethyl-1,5,5-trimethylbicyclo[2.2.1]heptan-6-ol; ethyl formate; ethyl heptanoate; ethyl hexanoate; ethyl 3-hydroxybutanoate; ethyl 3-hydroxyhexanoate; ethyl 2-methylbutanoate; ethyl octanoate; ethyl 3-methylbutanoate; ethyl propionate; 4-ethylphenol; pent-1-en-3-one; 2-methyl-5-propan-2-ylcyclohexa-1,3-diene; 7,11-dimethyl-3-methylidenedodeca-1,6,10-triene; 2-ethyl-4-hydroxy-5-methylfuran-3-one; (E)-3,7-dimethylocta-2,6-dien-1-ol; (E)-3,7-dimethylocta-2,6-dien-1-yl acetate; grapefruit oil; hexanal; hexaoic acid; E-hex-2-enal; (Z)-hex-3-en-1-ol; (Z)-hex-3-en-1-yl acetate; (E)-4-(2,6,6-trimethyl-1-cyclohex-2-enyl)but-3-en-2-one: (E)-4-(2,6,6-trimethylcyclohex-1-en-1-yl)but-3-en-2-one; lemon oil; lemon oil terpeneless; lime oil; lime oil terpeneless; 3,7-dimethylocta-1,6-dien-3-ol; 3,7-dimethylocta-1,6-dien-3-yl acetate: 3-hydroxy-2-methyl-4H-pyran-4-one; mandarin oil, 4-methyl-4-sulfanylpentan-2-one; 2-(4-methylcyclohex-3-en-1-yl)propane-2-thiol; mercapto-para-menthan-3-one; methyl acetate; methyl 2-aminobenzoate; 2-methyl-butanoic acid; methyl 3-phenylprop-2-enoate; methyl 3-oxo-2-pentylcyclopentaneacetate; 5-methylfuran-2-carbaldehyde; 7-methyl-3-methyleneocta-1,6-diene; (Z)-3,7-dimethylocta-2,6-dien-1-yl acetate; 5-pentyloxolan-2-one; nonanal; 4,4a-dimethyl-6-(prop-1-en-2-yl)-4,4a,5,6,7,8-hexahydronaphthalen-2(3H)-one; 5-butyloxolan-2-one; octanal; octanoic acid; orange cold pressed oil; orange essence oil: orange oil terpenes; orris concrete; osmanthus absolute; 2,3-pentanedione; 3-methylbutyl acetate; 3-methylbutyl 3-methylbutanoate; propyl acetate: rose oil: (2E,6E,9E)-2,6,10-trimethydodeca-2,6,9,11-tetraenal; (2E,6E)-2,6-dimethyl-10-methylidenedodeca-2,6,11-trienal; tangerine cold pressed oil; tarragon oil; 4-methyl-1-propan-2-ylcyclohex-3-en-1-ol, 1-methyl-4-propan-2-ylcyclohexa-1,3-diene; 2-(4-methyl-1-cyclohex-3-enyl)propan-2-ol; 1-methyl-4-(propan-2-ylidene)cyclohex-1-ene; 2-(4-methylcyclohex-3-en-1-yl)propan-2-yl acetate, 4a,5-dimethyl-3-prop-1-en-2-yl-2,3,4,5,6,7-hexahydro-1H-naphthalene; 4-hydroxy-3-methoxybenzaldehyde; and mixture thereof. Without being bound by any theory, it may be expected that, under such conditions, the flavor ingredients will partition between the oil phase and the polar phase of the concentrate, depending on their polarity.

In particular embodiment of the present disclosure, the level of the at least one flavor ingredient is from 0.3 wt.-% to 40 wt.-%, in another embodiment from 1 to 5 wt.-%, in another embodiment from 7 to 25 wt.-%, in yet another embodiment from 10 to 20 wt.-%, based on the total weight of the emulsion of the invention or the concentrate or concentrate emulsion or the invention.

In one embodiment, the nutraceuticals are selected from the group consisting of vitamins, carotenoids, and antioxidants or mixtures thereof, such as carotenoids, omega-3, fatty acids, polyphenols, flavonoids, phytoesterols and tocopherols.

In particular embodiments of the present disclosure, the colorants and nutraceuticals that are suitable in the context of the present disclosure may be selected from the group consisting of retinol, retinyl acetate or retinyl palmitate, tocotrienols and tocopherol, vitamin D2 (ergocalciferol) and D3 (cholecalciferol), vitamin K, astaxanthin, lutein (such as from Tagetes erecta flowers), lutein esters, fucoxanthin, curcuminoids, such as curcumin, demethoxycurcumin (DMC), and bisdemethoxycurcumin (BDMC), capsaicins, such as capsaicin, dihydrocapsaicin, and nordihydrocapsaicin, carotene, Algae carotene (like from Dunaliellasalina), fungal carotene (like from Blakeslea trispora), beta-carotene, lycopene, paprika extracts (such as from Capsicum annuum Linne fruits), norbixin (such as from Bixa Orellana), bixin (such as from Bixa Orellana), Annatto, zeaxanthin, phytosterols, vinpocetine, resveratrol, epigallocatechin-gallate (EGCE), anthocyanins, polyphenol, isoflavone, phytoestrogene, cannabinoides, betanins, carmins, quercetin, phytosterols, resveratrol ubiquinol and ubiquinone, silymarin (such as from Milk Thistle), gingerols/shagoals, alkamides (such as from Echinacea), omega-3s (DHA (docosahexaenoic acid), carnosic acid, carnosol, chlorogenic acids, annatto and EPA (eicosapentaenoic acid)) or mixtures thereof.

In particular embodiments, the benefit agent is Astaxanthin ((6S)-6-hydroxy-3-[(1E,3E,5E,7E,9E,11E,13E,15E,17E)-18-[(4S)-4-hydroxy-2,6,6-trimethyl-3-oxocyclohexen-1-yl]-3,7,12,16-tetramethyloctadeca-1,3,5,7,9,11,13,15,17-nonaenyl]-2,4,4-trimethylcyclohex-2-en-1-one) and/or beta-carotene (1,3,3-trimethyl-2-[(1E,3E,5E,7E,9E,11E,13E,15E,17E)-3,7,12,16-tetramethyl-18-(2,6,6-trimethylcyclohexen-1-yl)octadeca-1,3,5,7,9,11,13,15,17-nonaenyl]cyclohexene).

Colorants and nutraceutical agent may be used in pure form or in the form of an oleoresin, an extract or a powder. The concentration of the pure colorant and nutraceutical agent in oleoresins, extracts and powders may be less than 100 wt %, for example 5 wt.-%, 15 wt.-%, 30 wt %, 50 wt.-% or 75 wt.-%.

In particular embodiments, the extract comprising the benefit agent is in the form of a solution in ethanol or methanol, or in a mixture of ethanol and/or methanol and water. The extract may optionally be dried to remove any excess solvent.

In particular embodiment of the present disclosure, the level of the pure nutraceutical is from 0.01 wt.-% to 25 wt.-%, in another embodiment from 0.1 to 10 wt.-%, in yet another embodiment from 0.5 to 5 wt. %, based on the total weight of the emulsion of the invention or the concentrate or concentrate emulsion or the invention.

In particular embodiments of the present disclosure, other oils that are different from oat oil may be admixed with oat oil, such as crude, refined, or transformed vegetable oils, as well as fractions of vegetable oils. Fractions comprising middle chain triglycerides are particularly suitable for the sake of the present invention in the case the at least one benefit agent is at least one flavor ingredient because of their excellent compatibility with both flavor oils and oat oil. Other vegetable oils that may be used include coconut oil, olive oil, sun flower oil, rapeseed oil, safflower oil, soy bean oil and raps oil. These oils have the advantage of forming larger oil droplets that are especially useful in the case of turbid food and beverage products. Furthermore, these oils improve the storage stability of the small droplets that are useful for transparent to hazy food and beverage products. Without being bound by any theory, the applicant believes that these oils generally limit the so-called Ostwald ripening process that may otherwise destabilize emulsions.

In one embodiment, the vegetable oil product is a vegetable oil fraction comprising medium chain triglycerides, more particularly C 8 to C 12 triglycerides.

In one embodiment, the level of vegetable oil product is from 0.5 to 40 wt.-%, in another embodiment from 1 to 25 wt.-%, based on the total weight of the emulsion of the invention or the concentrate or concentrate emulsion or the invention.

In one embodiment, transparent to hazy food and beverage products may comprise from 0.5 to 20 wt.-%, or from t to 10 wt.-%, or from 0.5 to 5 wt.-%, or from 2 to 4 wt.-% of vegetable oil product, based on the total weight of the concentrate.

In one embodiment, the emulsion or the concentrate or the concentrate emulsion according to the invention, further comprise from 0.5 to 40 wt.-%, more particularly from 1 to 25 wt.-% of a vegetable oil product, wherein the vegetable oil product is selected from the group consisting of a vegetable oil, a transformed vegetable oil, or a vegetable oil fraction, more particularly a vegetable oil fraction comprising medium chain triglycerides, more particularly C 8 to C 12 triglycerides, and wherein the additional vegetable oil product is not derived from oat oil.

In particular embodiments of the present disclosure, the emulsion of the invention or the concentrate or concentrate emulsion or the invention additionally comprise a weighting agent.

Suitable weighting agents include any of those weighting agents known in the art for use in beverage compositions. Examples of suitable weighting agents include, but are not limited to sucrose esters, such as saccharose acetate isobutyrate (SAIB), polyol fatty acid esters, polyol benzoates, dammar gum, rosin gums, ester gums, and the like Weighting agent prevents dispersed oil phases that have a lower density than the polar continuous phase to phase separate by creaming.

When a weighting agent is employed, it may be used in amounts up to 150 wt % based on the total amount of the at least one benefit agent (such as the flavor ingredient) contained in the emulsion of the invention or the concentrate or concentrate emulsion or the invention.

In one embodiment, the emulsion or the concentrate or concentrate emulsion or the invention, further comprise a weighting agent, wherein the weighting agent is selected from the group consisting of sucrose esters, such as saccharose acetate isobutyrate (SAIB), polyol fatty acid esters, polyol benzoates, dammar gum, rosin gums, and ester gums, and wherein the level of the weighting agent is up to 150 wt.-% based on the total amount of the flavor ingredients contained in the concentrate.

In another aspect, the present disclosure provides a method to obtain the concentrate of the invention by performing the steps of
a. Mixing the oat oil, the at least one benefit agent and optionally the vegetable oil product, in order to form a mix;
b. Adding this mix to the at least one polyol and/or a native or modified carbohydrate;
c. Optionally adding at least one saponin and/or water, and
d. Mixing all ingredients to obtain a concentrate.

In particular embodiments of the present disclosure, the method additionally comprises the step of:
e. Applying high or low energy emulsification methods to the concentrate, in order to obtain an emulsified concentrate

In regard to step d., the concentrate may be obtained by applying first a pre-emulsification step for example by using a propeller, a blade, or a rotor-stator homogenizer Concentrate of this type may be added to a variety of food products, such as ice-creams, popsicles and any food matrices with which the benefit agent must be made compatible.

In another embodiment in regard to step d) the polar and lipid phase are mixed together directly during the low energy emulsification step.

In regard to step e., the concentrate obtained in step d. may be emulsified by using a high pressure homogenizer. The composition may be homogenized with high pressure homogenization by passing said composition one or mom time through a valve. In general the pressure applied is about 10 to 150 MPa or from about to 20 to 100 MPa (which includes a range from about 30-100 MPa, such as 35 or 40 MPa). The number of times the composition passes through the valve may be 1 to 10 times, (which included 2-5, e.g. 3 times). In case that a two-stage homogenization valve is used, the composition is passed through two valves, wherein the pressure in the second valve is set to about 5-50% (e.g. 10-30%, including 25%) of the pressure in the first valve. In one embodiment, the pressure in the second valve is set to about 3-50% of the pressure in the first valve. The emulsion is homogenized for 1-10 passes through the two valves (which included 2-5, e.g. 3 passes). Optionally, a cooling step in between passes may be applied, in particular when the temperature of the emulsion exceeds 40° C., which otherwise may lead to changes in the flavor profile, in case that temperature sensitive flavors are used.

The emulsified concentrate obtained in step e, may be added to food and beverage products, such as drinkable water, a fruit juice, a fruit juice concentrate, a fruit pulp, or a mixture thereof, as well as to candies and gums.

The emulsion of the invention or the emulsified concentrate of the invention may be added to a food or beverage product, a nutritional supplement, a nutraceutical formulation, a fragrance or flavouring, a pharmaceutical or veterinary formulation or an oenological or cosmetic formulation.

The invention is also related to a combination (or combination of the invention) of at least one oat oil and at least one saponin for stabilize emulsions.

The invention is also related to the use of a combination of at least one oat oil and at least one saponin as an emulsifying agent.

The invention is also related to a method for stabilize emulsions that comprises mixing the combination of at least one oat oil and at least one saponin in one or both of the aqueous phase or the lipid phase of the ingredients of an emulsion.

Oat oils, saponins have been described previously. For the avoidance of doubt, preferences, options, particular features and the like indicated for the emulsions or concentrates of the invention, should, unless the context indicates otherwise, be regarded as to apply to the combination of the invention or the use of said combination of the invention.

For example, in one embodiment of the combination of the invention, or of the use or the method that uses a combination of the invention, the oat oil(s) comprises 8 wt.-% or more of ceramides and glycolipids.

In another preferred embodiment of the combination of the invention, or of the use or the method that uses a combination of the invention, at least 4%, or at least 5%, or at least 6%, or at least 8%, or at least 10%, or at least 11%, or at least 12%, or at least 13%, or at least 14%, or at least 15%, or at least 16%, or at, least 17%, or at, least 18%, or at least 19%, or at least 20%, or at least 22%, or at least 23%, or at least 24%, or at least 25%, or at least 26%, or at least 27%, or at least 28%, or at least 29%, or at least 30%, or at least 31%, or at least 33%, or at least 35%, or at least 40% by weight of the oat oil are polar lipids.

In another preferred embodiment of the combination of the invention, or of the use or the method that uses a combination of the invention, the at least one saponin is selected from the group consisting of quillaja saponins, tea saponins, licorice saponins, beet root saponins, fenugreek saponin, alfalfa saponin, fennel saponin, garlic saponin, asparagus saponin, quinoa saponin, sugar beet saponins, ginseng saponins, glycyrrhizin, oat bran saponins, and yucca saponins or mixtures thereof.

The combination of the invention may be used as emulsifier in a food or beverage product, a nutritional supplement, a nutraceutical formulation, a fragrance or flavouring, a pharmaceutical or veterinary formulation or an oenological or cosmetic formulation.

The present invention is also related to a food or beverage, a nutritional supplement, a nutraceutical formulation, a fragrance or flavouring, a pharmaceutical or veterinary formulation or an oenological or cosmetic formulation comprising an emulsion or a concentrate or concentrate emulsion of the invention.

As used herein, “food” refers at least to an edible food product, such as, a solid, semisolid or liquid (such as beverage) food stuff product known in the art. Mention may be made of food products such as, but not limited to, emulsified sauces, frozen ice cream or desserts, yogurt, baby/children foods, fruit leathers/roll ups, dairy yogurts, soy yogurts, granola bars/snacks, crackers, fruit bars, energy bars, nutritional bar.

As used herein, the term “beverage” or “beverage composition” refers to a liquid drink that is appropriate for human or animal consumption. Mention may be made, of beverages, but not limited to, for example, energy drinks, flavored water, fruit smoothies, sport drinks, fruit juices (e.g., juice drinks and full strength fruit juice), carbonated sodas/juices, shakes, protein drinks (e.g., dairy, soy, rice or other), meal replacements, drinkable dairy yogurts, drinkable soy yogurts, teas, coffees, cola drinks, fortified waters, low acid beverages as defined in 21 C.F.R § 113, acidified beverages as defined in 21 C.F.R. § 114, syrups, cordials, dilutables such as squashes, health drinks, functional beverages (e.g., nutraceuticals), nectars, tonics, horchata (i.e., vegetable and/or rice components made into a beverage), frozen carbonated beverages and frozen non-carbonated beverages.

In a preferred embodiment, the food product is selected from beverages such as carbonated and non-carbonated beverages (such as fruit drinks, teas, coffees, enhanced waters etc), vegetable milks, ice creams, creamers, margarines, and emulsified sauces (such as mayonnaise, ketchup, etc).

Food encompasses the following general food categories, as defined by the Food and Drug Administration (FDA): baked goods and baking mixes, including all ready-to-eat and ready-to-bake products, flours, and mixes requiring preparation before serving; beverages, alcoholic, including malt beverages, wines, distilled liquors, and cocktail mix, beverages and beverage bases, non-alcoholic, including only special or spiced teas, soft drinks, coffee substitutes, and fruit and vegetable flavored gelatin drinks; breakfast cereals, including ready-to-eat and instant and regular hot cereals; cheeses, including curd and whey cheeses, cream, natural, grating, processed, spread, dip, and miscellaneous cheeses; chewing gum, including all forms; coffee and tea, including regular, decaffeinated, and instant types; condiments and relishes, including plain seasoning sauces and spreads, olives, pickles, and relishes, but not spices or herbs; confections and frostings, including candy and flavored frosting, marshmallows, baking chocolate, and brown, lump, rock, maple, powdered, and raw sugars; dairy product analogs, including nondairy milk, frozen or liquid creamers, coffee whiteners, toppings, and other nondairy products; egg products, including liquid, frozen, or dried eggs, and egg dishes made therefrom, i.e., egg roll, egg foo young, egg salad, and frozen multicourse egg meals, but not fresh eggs; fats and oils, including margarine, dressings for salads, butter, salad oils, shortenings and cooking oils; fish products, including all prepared main dishes, salads, appetizers, frozen multicourse meals, and spreads containing fish, shellfish, and other aquatic animals, but not fresh fish; fresh eggs, including cooked eggs and egg dishes made only from fresh shell eggs; fresh fish, including only fresh and frozen fish, shellfish, and other aquatic animals; fresh fruits and fruit juices, including only raw fruits, citrus, melons, and berries, and home-prepared “lemonades” and punches made therefrom; fresh meats, including only fresh or home frozen beef or veal, pork, lamb or mutton and home-prepared fresh meat-containing dishes, salads, appetizers, or sandwich spreads made therefrom, fresh poultry, including only fresh or home-frozen poultry and game birds and home-prepared fresh poultry-containing dishes, salads, appetizers, or sandwich spreads made therefrom; fresh vegetables, tomatoes, and potatoes, including only fresh and home-prepared vegetables; frozen dairy desserts and mixes, including ice cream, ice milks, sherbets, and other frozen dairy desserts and specialties; fruit and water ices, including all frozen fruit and water ices; gelatins, puddings, and fillings, including flavored gelatin desserts, puddings, cus-tards, parfaits, pie fillings, and gelatin base salads, grain products and pastas, including macaroni and noodle products, rice dishes, and frozen multicourse meals, without meat or vegetables; gravies and sauces, including all meat sauces and gravies, and tomato, milk, buttery, and specialty sauces, hard candy and cough drops, including all hard type candies; herbs, seeds, spices, seasonings, blends, extracts, and flavorings, including all natural and artificial spices, blends, and flavors; jams and jellies, home-prepared, including only home-prepared jams, jellies, fruit butters, preserves, and sweet spreads; jams and jellies, commercial, including only commercially processed jams, jellies, fruit butters, preserves, and sweet spreads; meat products, including all meats and meat containing dishes, salads, appetizers, frozen multicourse meat meals, and sandwich ingredients prepared by commercial processing or using commercially processed meats with home preparation; milk, whole and skim, including only whole, low fat, and skim fluid milks, milk products, including flavored milks and milk drinks, dry milks, toppings, snack dips, spreads, weight control milk beverages, and other milk origin products; nuts and nut products, including whole or shelled tree nuts, peanuts, coconut, and nut and peanut spreads, plant protein products, including the National Academy of Sciences/National Research Council “reconstituted vegetable protein” category, and meat, poultry, and fish substitutes, analogues, and extender products made from plant proteins; poultry products, including all poultry and poultry-containing dishes, salads, appetizers, frozen multicourse poultry meals, and sandwich ingredients prepared by commercial processing or using commercially processed poultry with home preparation; processed fruits and fruit juices, including all commercially processed fruits, citrus, berries, and mixtures; salads, juices and juice punches, concentrates, dilution, “lemonades”, and drink substitutes made therefrom; processed vegetables and vegetable juices, including all commercially processed vegetables, vegetable dishes, frozen multicourse vegetable meals, and vegetable juices and blends; snack foods, including chips, pretzels, and other novelty snacks; soft candy, including candy bars, chocolates, fudge, mints, and other chewy or nougat candies; soups, home-prepared, including meat, fish, poultry, vegetable, and combination home-prepared soups; soups and soup mixes, including commercially prepared meat, fish, poultry, vegetable, and combination soups and soup mixes; sugar, white, granulated, including only white granulated sugar; sugar substitutes, including granulated, liquid, and tablet sugar substitutes; and sweet sauces, toppings, and syrups, including chocolate, berry, fruit, corn syrup, and maple sweet sauces and toppings.

The emulsion of the invention or the emulsified concentrate of the invention may be added to a food or beverage products, a nutritional supplement, a nutraceutical formulation, a fragrance or flavouring, a pharmaceutical or veterinary formulation or an oenological or cosmetic formulation at an amount such that from 0.001 to about 20 wt.-% such as 0.001 to about 0.5 wt.-%, or from 1.5% to about 3% of the at least one benefit agent comprised in said concentrate is added to the beverage or food product.

In one embodiment, the emulsion of the invention can be in the form of a food product or beverage or a nutritional supplement, a nutraceutical formulation, a fragrance or flavouring, a pharmaceutical or veterinary formulation or an oenological or cosmetic formulation. That is for example a food product or beverage that is in form of an emulsion such as emulsified sauces, vegetable beverages, creamers, sweets, dairy products, etc. In this case, the final product comprises from at least 99 wt.-%, at least 95 wt.-%, at least 90 wt.-%, at least 80 wt.-%, at least 70 wt.-%, at least 60 wt.-%, at least or at least 50 wt.-%, at least 40 wt.-%, at least 30 wt.-% or at least 20 wt.-% of the emulsion of the invention or the emulsified concentrate of the invention.

In one embodiment the emulsion of the invention is the final food product or beverage (such as vegetable milks or margarines) or a nutritional supplement, a nutraceutical formulation, a fragrance or flavouring, a pharmaceutical or veterinary formulation or an oenological or cosmetic formulation and thus the emulsion of the invention or the emulsified concentrate of the invention is at least 95 wt.-% or 100 wt.-% of the final product.

In one embodiment, the beverage is a fruit juice that may be obtained by pressing fresh fruit and removing the insoluble pulp, skin and seeds.

A fruit juice concentrate is processed to remove a defined proportion of the natural water content found in the fruit and produce a concentrated product which is smaller in volume.

A fruit pulp (or puree) is a thick, smooth product, which has been processed such that the insoluble fibrous parts are broken up so as to be able to fit through a fine sieve. The concentrate may be diluted in water, or admixed with a fruit juice or a fruit juice concentrate, which can be further diluted in an aqueous phase comprising, optionally, at least one citrate compound to form a beverage composition according to the present disclosure, wherein the level of the citrate compound in the aqueous phase is set in such a way that the level of the citrate compound in the beverage composition is from about 0.3 to about 0.7 wt % The citrate compound may be selected from sodium citrate, potassium citrate, or mixtures thereof. The beverage composition may also include malic acid, acetic acid, ascorbic acid, lactic acid, tartaric acid and phosphoric acid.

In one embodiment the beverage composition may be carbonated.

For example an emulsified food product or beverage (such as a vegetable beverage emulsion or creamer) or a nutritional supplement, a nutraceutical formulation, a fragrance or flavouring, a pharmaceutical or veterinary formulation or an oenological or cosmetic formulation can be prepared as follows:
a) mixing ingredients of an aqueous phase
b) mixing ingredients of a lipid phase; (such as a vegetal oil or fat, etc)
c) dispersing oat oil and at least one saponin (such as quillaja) in one or both of the aqueous phase or the lipid phase; and
d) homogenizing the two phases to form an emulsion.

In a preferred embodiment, the saponin (such as quillaja) is mixed to the aqueous phase and the oat oil is mixed to the lipid phase.

A first mixing (step d) to form a pre-emulsion (such as an emulsified concentrate) may be performed. In a further step e) the pre-emulsion (or emulsified concentrate) may be supplemented with sugars, salts and other components (such as more water etc) and a second mixing is performed to achieve a final emulsified product.

In another embodiment, all the components of the emulsified product (such as a food or beverage, such as a vegetal beverage or a creamer) are dispersed in one of the phases (lipid or aqueous phase) and after step d) the final product (such as food or beverage) is obtained

In one embodiment, product is a beverage such as a vegetal beverage and the vegetal oil or fat may be selected from: palm oil, coco oil, olive oil, rapeseed oil, almond oil, rice brand oil, safflower oil, peanut oil, avocado oil, walnut oil, flaxseed oil, sesame oil, hazelnut oil, cottonseed oil, grape seed oil, pumpkin seed oil, quinoa oil, hemp oil, soybean oil.

Additionally, other products can be added during the production of the emulsion for a food or beverage, the nutritional supplement, the nutraceutical formulation, the fragrance or flavouring, the pharmaceutical or veterinary formulation or the oenological or cosmetic formulation, such as benefit agents such as colors, flavors, nutraceuticals, etc. Also sugars, acidifiers, texturizers, and other food ingredients can be added to any or both of the phases during the fabrication of the product (such as a food or beverage emulsion).

Examples of benefit agents such as colors, flavors and nutraceuticals have been already described herein.

Thus the invention is also related to a food or beverage, a nutritional supplement, a nutraceutical formulation, a fragrance or flavouring, a pharmaceutical or veterinary formulation or an oenological or cosmetic formulation comprising an emulsion or a concentrate or concentrate emulsion of the invention.

Also, the invention is related to a food or beverage, a nutritional supplement, a nutraceutical formulation, a fragrance or flavouring, a pharmaceutical or veterinary formulation or an oenological or cosmetic formulation emulsion obtained using one of the methods herein described comprising oat oils and at least one saponin (such as quillaja) as emulsifiers.

In alternative embodiments, the emulsion of the invention or the emulsified concentrate of the invention may be in the form of a powder which may be prepared by standard methods known in the art such as spry drying etc.

As an example, the emulsion of the invention or the emulsified concentrate of the invention may be in the form of a powder which may be prepared performing the steps of:
a. Mixing the oat oil, the at least one benefit agent and optionally the vegetable oil product, in order to form a mix;
b. Adding this mix to an aqueous solution of at least one native modified carbohydrate;
c. Optionally adding at least one saponin;
d. Applying low shear mixing to obtain a concentrate;
e. Applying high energy emulsification to the coarse emulsion to reduce the emulsion droplet diameter; and
f. Spray drying the emulsion obtained in step e).

In respect to step b), the at least one native carbohydrate and/or proteins may be selected from the group comprising gum Arabic acacia Senegal or gum Arabic acacia Seyal, whereas the at least one modified carbohydrate may be selected from the group comprising starch octenyl succinate, dextrins and maltodextrins. In another embodiment, the native modified carbohydrate may not be necessary.

In particular embodiments, the emulsion of the invention or the emulsified concentrate of the invention comprises oat oil, gum Arabic and/or modified starch, at least 20 wt.-% of benefit agent and an extract obtainable from quillaja, wherein the composition concentrate comprises particles having an average diameter of from about 100 nm to about 10000 nm.

In further alternative embodiments, the emulsions of the invention or the emulsified concentrate obtained in step e) may be sprayed on to fluidized core particles using a pressure, sonic or a pneumatic nozzle, preferably, a two-fluid nozzle, or a three-fluid nozzle which is inserted either on the top (top spray), lateral (lateral spray), tangential (tangential spray), or at the bottom (bottom spray) of the fluidized bed. The emulsion may be applied to the core particles in a spray coating process, wherein the core particles size or diameter and particle size or diameter distribution are commensurate with the desired final delivery system particle size and particle size distribution. The spray coating process may be performed in a fluidized bed dryer, a drum coater, a pan coater or a Loedige mixer, or any mechanical device, where the particulate core material is put in motion in such a way that the surface of the particles is homogeneously exposed to the spray providing the atomized emulsion or emulsified concentrate.

The inventors have further discovered that the emulsion of the invention and the concentrate of the invention can protect the at least one benefit agent (such as colors, nutraceuticals or flavours) from oxidation (such as in example 13) or can increase the bio-accessibility of an active (see example 5). As it can be seen in table 5, the benefit agent astaxanthin is better protected against digestive conditions in both in vitro model stomach and in vitro model small intestine if a polar oat oil fraction is used in combination with quillaja saponins as emulsifying system, compared to oleoresin alone or emulsified using a combination of quillaja saponins and lecithins.

Thus the present invention is also related to the use of an emulsion of the invention or a concentrate emulsion of the invention to increase the bio-accessibility of an active or benefit agent.

The present invention is also related use of an emulsion of the invention or a concentrate emulsion of the invention for increasing the bioaccessibility of astaxanthin.

Thus the present invention is also related to the use of an emulsion of the invention or a concentrate emulsion of the invention to prevent or decrease the oxidation of an active or benefit agent.

The present invention is also related use of an emulsion of the invention or a concentrate emulsion of the invention to prevent the oxidation of omega 3.

The present invention is also related to a method for improving bioaccessibility, bioavailability, bioefficacy and/or bioactivity of a benefit agent in mammals comprising the administration of said benefit agent in the form of a composition comprising (i) an emulsion of the invention (such as a concentrate emulsion or the invention) comprising oat oils and at least one saponin (such as quillaja saponin) as emulsifiers and (ii) and a benefit agent (such as a nutraceutical, such as astaxanthin).

A method for improving bio-accessibility, bioavailability, bio-efficacy and/or bioactivity of a benefit agent in mammals comprising the administration of said benefit agent in the form of a composition comprising (i) an emulsion or a concentrate of the invention as emulsifiers and (iii) and a benefit agent.

A method for preventing the oxidation of a benefit agent in an animal (such as mammals or humans) comprising the administration of said benefit agent in the form of a composition comprising (i) an emulsion or a concentrate of the invention as emulsifiers and (iii) and a benefit agent.

In one embodiment, the emulsion or concentrate of the invention comprises at least one saponin.

The invention is also related to the use of a composition comprising (i) emulsion or a concentrate emulsion according to the invention and (ii) a benefit agent, for improving the bio accessibility, bioavailability, bioefficacy and/or bioactivity of said benefic agent in mammals.

The invention is also related to the use of a composition comprising (i) an emulsion of the invention (such as a concentrate emulsion or the invention) comprising oat oils and at least one saponin (such as quillaja saponin) as emulsifiers and (ii) and a benefit agent (such as a nutraceutical, such as astaxanthin) for improving bio accessibility, bioavailability, bioefficacy and/or bioactivity of said benefic agent in humans or in an animal such as a mammal. Animals may be mammals, like dogs, cats, pigs, cows, etc, or birds, reptiles, etc.

In one embodiment, the improvement in bioaccessibility, bioavailability, bioefficacy and/or bioactivity of a benefit agent (such as a nutraceutical, such as astaxanthin) in mammals is due to improved gastrointestinal resistance of the benefit agent and/or improved absorption of the benefit agent by intestinal cells and/or improved blood circulation.

The nutraceutical may be selected from the nutraceuticals already described herein.

In a preferred embodiment of the methods and uses described herein, the active or benefit agent (such as a nutraceutical) is a lipid or is liposoluble. In another embodiment, the nutraceutical is in the form of an oleoresin.

In a preferred embodiment the nutraceutical is astaxanthin oleoresin obtained from example from algae with at least 10% by weight of total astaxanthin (i.e. 74.8% astaxanthin monoesters, 20.7% diesters and 45% free astaxanthin by weight of the total astaxanthin).

In one embodiment the mammal is a human.

For the avoidance of doubt, preferences, options, particular features and the like indicated for a given aspect, feature or parameter of the invention should, unless the context indicates otherwise, be regarded as having been disclosed in combination with any and all other preferences, options particular features and the like as indicated for the same or other aspects, features and parameters of the invention.

There now follows a series of examples that are provided solely for the purpose of illustration and are not intended to be limiting on the invention.

### FIGURES

FIG. 1. Lemonade. 0.1% QOOP vs 0.06% PP

FIG. 2. Dx(10)=The volume of sample particles with diameters smaller than this value is 10% Dx(50)=The volume of sample particles with diameters smaller and larger than this value are 50%. Also known as the median diameter. Dx(90)=The volume of sample particles with diameters below this value is 90%.

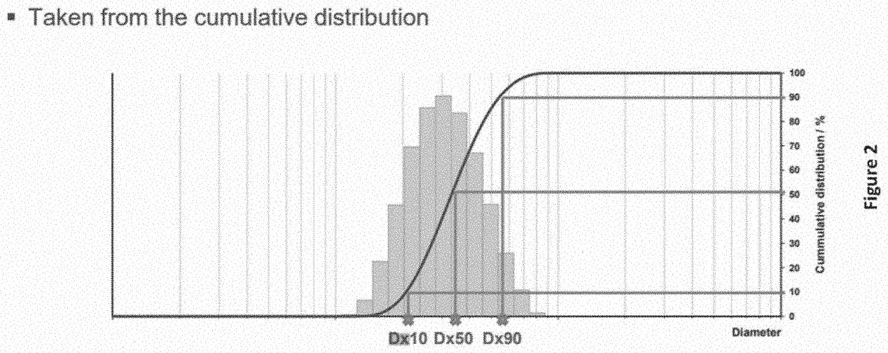

FIG. 3. Algal carotene. QOO AC vs SP AC.

FIG. 4. Fungal carotene—QOO FC vs SP FC.

FIG. 5. Lutein—QOO L vs SP L.

FIG. 6. Difference in opacity. A. Algal carotene; B. Fungal carotene; C. Paprika: D. Lutein.

FIG. 7. Paprika comparison, ring formation after 1 day in GAP.

FIG. 8. Margarines.

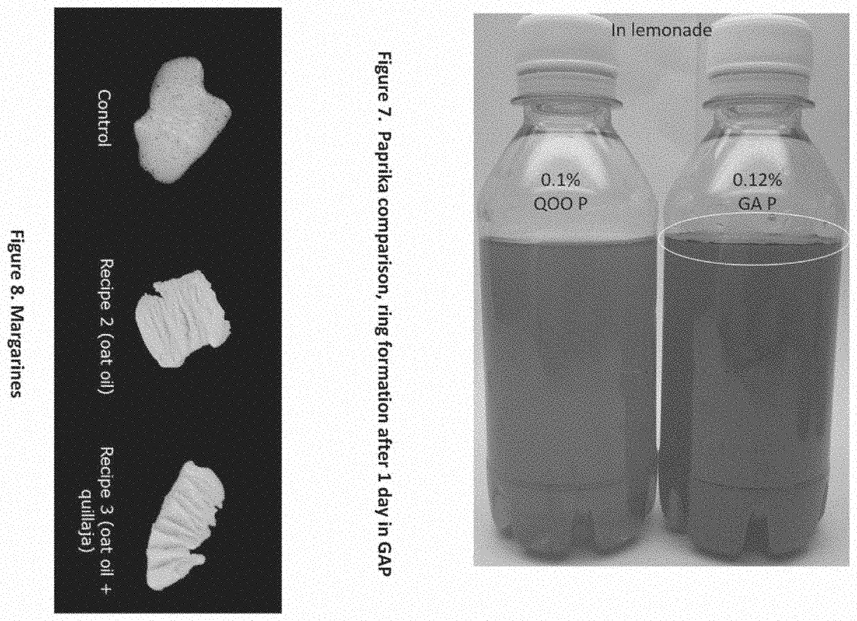

FIG. 9. Peroxide values and TBARS values for ex. 1, 2 and 3.

FIG. 10. Peroxide values and TBARS values for ex. 4, 5 and 6.

FIG. 11. Foam layer in emulsions. Quillaja versus quillaja and oat oil.

### EXAMPLES

### Example 1

### Preparation of Emulsified Flavored Concentrates for Transparent Beverages

A series of emulsified concentrates according to the present disclosure were obtained by performing, for each of them, the steps of:
1. Mixing a known amount of flavor oil with a known amount of vegetable oil (middle chain triglycerides (MCT) oil fraction, Miglyol 812, ex Oleo) and a known amount of polar oat oil fraction (PL 40, ex Swedish oat Fiber) (see Table 1) in a mixing vessel equipped with a magnetic stirrer operating at 300 rpm, in order to obtain an oil phase,
2. Mixing a known amount of glycerin and a known amount of water (see Table 1), in order to obtain a polar phase.
3 Mixing the oil phase and the polar phase with a Kinematica Polytron rotor-stator mixing equipment at a stirring rate of 5000 rpm for 3 minutes, in order to obtain a flavored concentrate;
4. Emulsifying each of these flavor concentrates by passing it three times through a two stage high-pressure homogenizer operating at a first stage valve pressure of 350 bar and a second stage valve pressure of 50 bar, in order to obtain and emulsified flavored concentrate.

In all examples, step 4 resulted in oil-in-polar phase emulsions

The polar oat oil fraction PL 40 used in this and in the following examples comprises 4.8±1.1 wt.-% ceramides, 3±0.6 wt.-% monogalactosyldiacylglycerols, 8±0.7 wt.-% digalactosyldiacylglycerols and 8±1.6 wt.-% unknown glycolipids.

The Z-average size of the oil droplet was measured by dynamic light scattering. The emulsions were diluted 1000 times with micro-filtered and degassed deionized water and immediately transferred a Malvern Zetasizer Nano ZS90 Dynamic Laser Light Scattering measurement instrument. The Z-average oil droplet size was then calculated using the software implemented in the instrument. The measurement was performed at room temperature.

The turbidity of beverages flavored with the emulsified flavor concentrates were prepared by diluting the emulsified flavor concentrates into drinkable water to a concentration of 0.3 g/L beverage. Each of these beverages were transferred to a 95 mm×25 mm borosilicate glass photometric cell of and the turbidity was determined by measuring the light scattering intensity at a wavelength of 460-600 nm and an angle of 12° (forward scattering). The turbidimeter was a Hach 2100N Laboratory Turbidimeter. The turbidimeter was calibrated using Formazin standard suspensions and the result given in Nephelometric Turbidity Units.

The compositions of the concentrates, the Z-average size of the oil droplets during and after emulsification and the turbidity of the beverages obtained by diluting the emulsified concentrates are shown in Table 1.

TABLE 1
Composition and properties of emulsified flavor concentrates containing polar oat oil fraction
PL 40 and transparent beverages obtained therefrom

| | Examples | | | | | | |
|---|---|---|---|---|---|---|---|
| | 1.1 | 1.2 | 1.3 | 1.4 | 1.5 | 1.6 | 1.7 |
| Lemon flavor | 11 | 11 | 11 | | | | |
| Orange flavor | | | | 9 | 11 | 11 | 11 |
| MCT oil Miglyol 812 [wt.-%] | | | | 2 | | | 2 |
| Oat oil PL 40 [wt.-%] | 2 | 3 | 4 | 2 | 2 | 6 | 6 |
| Glycerin [wt.-%] | 70 | 70 | 70 | 72 | 72 | 68 | 68 |
| Water [wt.-%] | 17 | 16 | 15 | 15 | 15 | 15 | 13 |
| Z-average particle size after 2 | 207 | 181 | 136 | 158 | 174 | n.d. | 158 |
| passes at t = 0 [nm] | | | | | | | |
| Z-average particle size after 3 | 193 | 163 | 134 | 136 | 157 | 107 | 129 |
| passes at t = 0 [nm] | | | | | | | |
| Z-average particle size after 3 | 156 | 157 | 133 | 137 | 137 | 130 | 126 |
| passes and 1 month at 40° C. [nm] | | | | | | | |
| Turbidity of beverage with 0.3 g/l | 21 | 19 | 20 | 18 | 21 | 14 | 16.6 |
| concentrate [NTU] | | | | | | | |
| Emulsion stability | stable | stable | stable | stable | stable | stable | stable |

All emulsified concentrates shown in Table 1 are stable over time and provide stable and transparent beverages upon dilution. A comparison between examples 1.1 and 1.3 for lemon flavor and of examples 1.5 and 1.6 for orange flavor shows that increasing the concentration of polar oat oil fraction PL 40 in the concentrate decreases the Z-average droplet size and the turbidity of a beverage obtained from these emulsified concentrates. Examples 1.4 and 1.5 show that part of the flavor oil may be replaced by MCT oil without significant changes in the emulsion properties. Finally, Example 1.7 shows that, combining orange oil, polar oat oil fraction PL 40 and MCT oil, a thermally stable emulsified concentrate having enhanced oil to polar phase ratio of 0.27 may be obtained.

These results confirm the suitability of the concentrate according to the disclosure for producing stable flavored emulsions and transparent beverages.

### Example 2

### Preparation of Emulsified Flavored Concentrates for Transparent Beverages, with Quillaja Saponins

A series of emulsified flavored concentrates were obtained by performing the same steps as in Example 1, except Quillaja extract, containing 15 wt.-% Quillaja saponins, was added to the polar phase in step 2.

The compositions of the concentrates, the Z-average size of the oil droplets during and after emulsification and the turbidity of the beverages obtained by diluting the emulsified concentrates, as described in Example 1, are shown in Table 2. The turbidity was measured at a dilution of 0.3 g/l of beverage just after dilution and after one day after dilution.

In Example 2.1 (comparative example) no oat oil was used.

TABLE 2
Composition and properties of emulsified flavor concentrates containing polar oat oil
fraction PL 40 and Quillaja saponins, and transparent beverages obtained therefrom

| | Examples | | | | | | |
|---|---|---|---|---|---|---|---|
| | 2.1 | 2.2 | 2.3 | 2.4 | 2.5 | 2.6 | 2.7 |
| Lemon Flavor | 10.8 | 11 | 11 | 11 | 11 | 11 | 11 |
| MCT oil Miglyol 812 [wt.-%] | 4 | 2 | 2 | 2 | 2 | 0 | 4 |
| Oat oil PL 40 [wt.-%] | | 2 | 2 | 4 | 4 | 2 | 2 |
| Glycerin [wt.-%] | 65.4 | 66 | 67.5 | 67.5 | 67.5 | 67.5 | 67.5 |
| Water [wt.-%] | | | 2.5 | 2.5 | 4.5 | 4.5 | 0.5 |
| Quillaja extract (15 wt.-% | 19.8 | 19 | 15 | 13 | 11 | 15 | 15 |
| saponins) [wt.-%] | | | | | | | |
| Z-average particle size after 2 | 171 | 144 | 151 | 139 | 150 | 176 | 158 |
| passes at t = 0 [nm] | | | | | | | |
| Z-average particle size after 3 | 143 | 124 | 122 | 119 | 127 | 159 | 135 |
| passes at t = 0 [nm] | | | | | | | |
| Z-average particle size after 3 | 171 | 121 | 125 | 134 | 168 | 129 | 143 |
| passes and 1 month at 40° C. [nm] | | | | | | | |
| Z-average particle size after 3 | 159 | 128 | 121 | 131 | 134 | 137 | 148 |
| passes and 3 months at 20° C. [nm] | | | | | | | |
| Turbidity of freshly prepared | 16 | 12 | 13 | 10 | 13 | 10 | 13 |
| beverage with 0.3 g/l concentrate [NTU] | | | | | | | |
| Turbidity of beverage with 0.3 g/l | | | 3 | 5 | | | |
| concentrate (after one day) [NTU] | | | | | | | |

All samples were stable under the storage conditions (1 month at 40° C. and 3 months at 20° C.

A comparison between Examples 2.1 and 2.2 shows that replacing half of the MCT oil by polar oat oil fraction PL 40 improves the quality of the emulsified concentrate by decreasing the Z-average droplet size and the turbidity of beverages obtained from these emulsified concentrate. Concomitantly, the stability of the emulsified concentrate over time and at elevated temperature is clearly improved. Furthermore, a comparison between Examples 2.1, 2.2 and 2.3 shows that, in the presence of polar oat oil fraction PL 40, the concentration of Quillaja extract can be reduced from 19.8 or 19 to 15 wt.-% without losing the quality of the emulsified concentrate. The concentration of Quillaja extract may even be further decreased to 13 wt.-% (Example 2.4), or even to 11 wt.-% (Example 2.5) by increasing the concentration of polar oat oil fraction PL 40 from 2 to 4 wt.-%, without compromising the quality of the emulsified concentrate at an unacceptable extent. Decreasing the concentration of Quillaja saponin has the advantage of (i) decreasing the amount of undesirable foam usually produced during the emulsification process when using this emulsifier and (ii) decreasing the risk, of off-taste potentially associated with the use of Quillaja extracts in beverages. Alternatively, using Quillaja saponins in combination with polar oat oil fraction PL 40, it is possible, at constant transparency, to deliver more flavor ingredients in a beverage than using Quillaja saponins alone.

Examples 2.6 and 2.7 show that stable emulsified concentrates may also be obtained in the absence of MCT oil or at higher concentration of MCT oil.

Examples 2.1, 2.2 and 2.7 show that concentrates according to the present disclosure may also comprise very low amounts of water and, because of the corresponding low water activity associated with such low amounts of water, may become self-preserving against biological contaminations. These emulsified concentrates do not require the addition of preservatives, such as potassium sorbate or sodium benzoate, and do not require maintaining acidic conditions in the concentrate, which are otherwise necessary for these preservatives to be active. The fact that acidification is not needed has a beneficial impact on flavor stability.

Examples 2.1, 2.2, 2.3, 2.4, 2.5 and 2.7 show that combining MCT oil, oat oil and Quillaja saponins, the Z-average droplet size of the emulsified concentrate is already lower after two passes in high-pressure homogenizer than in the case where Quillaja saponins is used alone, even at lower overall emulsifier concentration.

Example 2.3 and 2.4 show that after one day equilibration, the turbidity values decrease and reach the preferred domain of turbidity values below 10 NTU.

These results confirm the suitability of the concentrates according to the present disclosure for producing stable flavored emulsions and transparent beverages obtained therefrom.

### Example 3

### Preparation of Emulsified Flavored Concentrates for Cloudy Beverages with and without Quillaja Saponins

One emulsified concentrate (Example 2.1, with Quillaja saponins) was obtained by performing the same steps as in Example 2, using the concentrations shown in Table 3. Another emulsified concentrate (Example 2.2, without Quillaja saponins) was obtained by performing the same steps as in Example 1, using the concentrations shown in Table 3. The weighting agent ester gum and sucrose acetate isobutyrate were added in step a).

The compositions of the concentrates, the Z-average size of the oil droplets during and after emulsification and the turbidity of the beverages obtained by diluting the emulsified concentrates, as described in Example 1, are shown in Table 3. The turbidity was measured at a dilution of 1 g/l beverage, as described in Example 1.

TABLE 3
Composition and properties of emulsified flavor concentrates
containing polar oat oil fraction PL 40 and Quillaja saponins,
and cloudy beverages obtained therefrom

| | Example 2.1 | Example 2.2 |
|---|---|---|
| Orange Flavor | 8 | 8.7 |
| MCT Oil [wt.-%] | 24.7 | 0.7 |
| Oat oil PL 40 [wt.-%] | 2 | 4 |
| Glycerin [wt.-%] | 50.7 | 66 |
| Water [wt.-%] | 4.6 | 10 |
| Quillaja extract (15 wt.-% saponins) | 10 | |
| [wt.-%] | | |
| Sucrose Acetate Isobutyrate | | 4.9 |
| Ester gum | | 5.7 |
| Z-average particle size [nm] after step 3) | 245 | 299 |
| Z-average particle size after 3 passes | | 201 |
| Turbidity of beverage with at 1 g/l [NTU] | 470 | 298 |

As is known by one skilled in the art, the quality of both emulsified concentrate and beverage is comparable to those obtained by using Quillaja saponins. However, as mentioned in Example 2, suppressing or decreasing the concentration of Quillaja saponins in flavored emulsions has the advantage of (i) reducing foam formation and (ii) reducing the risk of off-taste potentially associated with the use of this emulsifier.

These results confirm the suitability of the concentrates according to the present disclosure for producing stable flavored emulsions and cloudy beverages obtained therefrom.

### Example 4

### Preparation of Emulsified Concentrates Containing Carotenoids. Quillaja Saponins and Oat Oil

A series of carotenoid-containing emulsified concentrates according to the present disclosure were obtained by performing the steps of:
1. Preparing an oil phase by mixing a known amount (see Table 4) of mix-carotene from algae (30% beta-carotene in olive oil, ex BASF) or astaxanthin oleoresin (obtained from Asta Real and containing 10% by weight of total astaxanthin (i.e. 74.8% astaxanthin monoesters, 20.7% diesters and 4.5% free astaxanthin by weight of the total astaxanthin) with a known amount of vegetable oil (medium-chain triglycerides MCT oil 60/40, comprising mainly caprylic acid and capric acid, ex Oleon), a known amount of mixed tocopherols (70% of total tocopherols, Xian Healthful Biotechnology Co., Ltd) and a known amount of polar oat oil fraction (PL 40, ex Swedish oat Fiber, see Example 1) in a vessel equipped with a magnetic stirrer hotplate operating at 500 rpm (HYCC SH-2 Laboratory) and heated at 80° C. in the case of astaxanthin and at 140° C. in the case of beta-carotene;
2. Preparing a polar phase by adding a known amount of glycerin or corn, a known amount of Quillaja extract Sapnov L 50, containing 30 wt.-% Quillaja saponins, and a known amount of water (see Table 4);
3. Mixing the oil and the polar phase under high shear, by using a SILVERSON Rotor-Stator mixer L5M, operating at 8000 rpm for 5 min, in order to obtain a concentrate;
4. Cooling the concentrates obtained in step 3) in an ice bath to room temperature while reducing the stirring speed to 5000 rpm, and stirring for 5 minutes;
5. Emulsifying each of the cooled concentrates obtained in step 4 by passing it two or three times through a two-stage high-pressure homogenizer operating at a first stage valve pressure of 700 bar and a second stage valve pressure of 70 bar, in order to obtain an emulsified concentrate.

In all examples, step 4 resulted in oil-in-polar phase emulsions. The volume-weighted mean D(4,3) of the oil droplet was measured by dynamic light scattering using a Nicomp PSS, Model Z3000 Dynamic Laser Light Scattering measurement instrument. The intensity-weighted droplet size distribution was converted to volume-weighted droplet size distribution by using the software implemented in the instrument, the density and the refractive index of the continuous glycerin/water polar phase. The emulsified concentrates were diluted 250 times with micro-filtered and degassed deionized water before measurement.

The results are listed in Table 4.

Colored beverages were prepared by diluting the emulsified concentrates into drinkable water to a concentration of 0.1 g/L beverage and the haze value of each of these beverages was measured by using a CM-3600d Konica Minolta spectrophotometer, according to ASTM method D1003, procedure A.

TABLE 4
Examples of nutraceutical-containing emulsified
concentrates with mean droplet size

| | Examples | | | | | |
|---|---|---|---|---|---|---|
| | 4.1 | 4.2 | 4.3 | 4.4 | 4.5 | 4.6 |
| Mix-carotene [wt.-%] | 3.4 | 3.4 | 3.4 | 3.4 | | |
| Astaxanthin oleoresin [wt.-%] | | | | | 10 | 10 |
| MCT oil [wt.-%] | 6.6 | 6.6 | 6.6 | 6.6 | | |
| Sunflower oil lecithins [wt. %] | | | | | | 2.5 |
| Oat oil PL 40 [wt.-%] | 2.5 | 2.5 | | | 2.5 | |
| Mixed tocopherol [wt.-%] | 1.5 | 1.5 | 1.5 | 1.5 | 1.5 | 1.5 |
| Glycerin [wt.-%] | 31.3 | 61 | 31.3 | 61 | 61 | 61 |
| Corn syrup [wt.-%] | 47 | | 47 | | | |
| Quillaja extract (30 wt.-% | 5 | 5 | 7.5 | 7.5 | 5 | 5 |
| saponins) [wt.-%] | | | | | | |
| Water [wt.-%] | 2.7 | 20 | 2.7 | 20 | 20 | 20 |
| D4,3 (nm) after 2 passes | 145 | 149 | 246 | 184 | 152 | 146 |
| D4,3 (nm) after 3 passes | 128 | 131 | 201 | 177 | 143 | 134 |
| Haze (%) after 2 passes | 8.6 | 11.3 | 53.2 | 26.8 | 10.0 | 9.7 |
| Haze (%) after 3 passes | 6.0 | 5.6 | 34.4 | 17.7 | 7.55 | 7.4 |

A comparison between Examples 4.1 and 4.3, as well as between Examples 4.2 and 4.4 confirms the benefit of using a polar oat oil fraction in terms of the Z-average droplet size of the emulsified concentrate, after two and three passes in high-pressure homogenizer, and the haze values of beverages obtained therefrom. Examples 4.5 and 4.6 show that sunflower lecithins may be advantageously replaced by the polar oat oil fraction PL 40.

These results confirm the suitability of the concentrate according to particular embodiments of the invention for producing stable carotenoids-containing emulsions and transparent colored beverages obtained therefrom.

### Example 5

Retention of Astaxanthin Bio-Accessibility after In-Vitro Digestion Assays

In this example, the bio-accessibility of astaxanthin provided in four different forms is compared. The first form (Example 5.1, control example) consisted of astaxanthin oleoresin dispersed in sunflower oil. The second form is a comparative example of an emulsified concentrate (Example 4.5, Table 5), comprising Quillaja extract, MCT oil, sunflower oil lecithins and glycerol. The third form is an example of an emulsified concentrate according to the present disclosure (Example 4.6, Table 5), comprising Quillaja extract, MCT oil, oat oil PL40 and glycerol. The fourth form (Example 5.2) was a spray-dried powder comprising polar oat oil fraction PL 40, Quillaja saponins and gum Arabic acacia Seyal instead of glycerol.

The spray-dried powder form (Example 5.2) was obtained by performing the steps of:
1. Heating a mixture of 10 g of astaxanthin oleoresin obtained from Asta Real and containing 10% by weight of total astaxanthin (i.e. 74.8% astaxanthin monoesters, 20.7% diesters and 4.5% free astaxanthin by weight of the total astaxanthin), 1.5 g of mixed tocopherols (70% of total tocopherols, Xi'an Healthful Biotechnology Co., Ltd) and 1.5 g of polar oat oil fraction PL 40 to a temperature of 80° C.; homogenizing this mixture by using HYCC SH-2 Laboratory Magnetic Stirrer Hot Plate at 500 rpm, a in order to form an oil phase;
2. Heating a mixture of 2.5 g of proprietary Quillaja extract Sapnov L 50, comprising 30% of saponins, 28 g gum from acacia Seyal and 53 g of water to a temperature of 70° C. and under stirring using a SILVERSON Rotor-Stator mixer L5M-A, in order to obtain a polar phase;
3. Mixing both oil and polar phase at 8000 rpm for 5 minutes, in order to obtain a concentrate, by using a SILVERSON Rotor-Stator mixer L5M-A;
4. Cooling the concentrate obtained in step 3) in ice bath to room temperature while decreasing the stirring speed to 5000 rpm;
5. Emulsifying the cooled concentrate by passing it two times through a two stage two-stage high-pressure homogenizer operating at a first stage valve pressure of 700 bar and a second stage valve pressure of 70 bar, in order to obtain and oil-in-polar phase emulsified concentrate.
6. Drying the emulsified concentrate obtained in step 5 by processing it through a spray dryer operating at 160° C. (inlet temperature), outlet temperature 90° C., air flow (1050 L/h) and a feed rate of (3-4 mL/min) in order to obtain 40 g of spray-dried emulsified concentrate powder, comprising 2.2 wt.-% astaxanthin.

The four forms (Examples. 4.5, 4.6, 5.1 and 5.2) were subjected to static in vitro simulation of gastrointestinal food digestion and compared with oleoresin as control sample, according to the method described in M. Minekus et al., “A standardized static in vitro digestion method suitable for food—an international consensus”, Food & Function, 5 (2014) p. 1113-24.

In a first step, the forms were subjected to physicochemical conditions prevailing in an in-vitro model stomach medium. The initial amount of astaxanthin was the same in all assays (0.072 g).

7.2 mL emulsified concentrate and 42.8 mL deionized water, or 50 ml of a mixture of 0.72 g of astaxanthin oleoresin and 49.68 g sunflower oil, or 0.33 g of spray-dried powder and 49.67 sunflower oil was mixed with (i) 37.5 mL of a simulated gastric fluid (SGF) stock solution consisting of 0.66 mL of a 0.5 molar potassium chloride solution in deionized water, 0.09 mL of a 0.5 molar potassium dihydrogen phosphate (KH2PO4) solution in deionized water, 1.19 mL of a 1 molar sodium hydrogen carbonate (NaHCO3) in deionized water, 1.12 mL of a 2 molar sodium chloride solution in deionized water, 0.04 mL of a 0.15 molar magnesium dichloride hexahydrate solution in deionized water, 005 mL of a 0.5 molar ammonium carbonate solution in deionized water, 0.12 mL of a 6 molar potassium hydrochloric acid solution in deionized water, and 44.24 mL of deionized water; (ii) 10 mL of 25.000 U/mL units pepsin (from porcine gastric mucosa, P6887, Sigma) in SGF stock solution (iii) 0.025 mL of a 0.3 molar calcium dichloride solution in deionized water and (iv) about 1 mL of a 1 molar hydrochloric acid solution in deionized water to decrease the pH to a 3.0. This mixture was stirred for 1.5 hours at 37° C., using a magnetic stirrer. 1 mL sample was withdrawn from each digestates for further determining the concentration of astaxanthin, as described hereinafter.

In second step, the emulsified concentrates were subjected to physicochemical conditions prevailing in an in-vitro model small intestine medium. 90 ml of the gastric chyme obtained in step 1 were mixed with (i) 35.1 mL of a simulated intestinal fluid (SIF) stock solution consisting of 1.31 mL of a 0.5 molar potassium chloride solution in deionized water, 0.15 mL of a 0.5 molar potassium dihydrogen phosphate (KH2PO4) solution in deionized water, 8.16 mL of a 1 molar sodium hydrogen carbonate (NaHCO3) in deionized water, 1.84 mL of a 2 molar sodium chloride solution in deionized water, 0.21 mL of a 0.15 molar magnesium dichloride hexahydrate solution in deionized water, 0.13 mL of a 6 molar potassium hydrochloric acid solution in deionized water, and 84.19 mL of deionized water; (ii) 22.5 mL of a 800 U/mL pancreatin (from porcine pancreas, 4×USP, P1750, Sigma) solution in SIF stock solution, 11.25 mL of bile extract (10 mM in the final mixture, and it needs to be determined, mM porcine bile extract, B8631, Sigma) and 14.1 mL of a 2000 U/mL units pancreatic lipase (from porcine pancreas, L3126, Sigma) solution in SIF stock solution, (iii) 0.18 mL of a 0.3 molar calcium dichloride solution in deionized water and (iv) about 0.675 mL of a 1 molar sodium hydroxide solution in deionized water to increase the pH to 70. This mixture was stirred for 2 hours at 37° C. ° C., using a magnetic stirrer. 1 mL sample was withdrawn from each digestates for further determining the concentration of astaxanthin, as described hereinafter. The astaxanthin present in the 0.5 mL samples obtained hereinabove was hydrolyzed and its concentration determined by high-pressure liquid chromatography/mass spectrometry (HPLC-MS). This was achieved by performing the steps of (i) diluting the samples in 3 mL ethanol; (ii) mixing this diluted sample with 0.5 mL of a 0.8 g potassium hydroxide solution in 1 mL deionized water for 2 minutes at 300 rpm and room temperature; (iii) adding 4 mL of a 2M solution of hydrochloric acid in deionized water, in order to stop the reaction, 2.6 mL of petroleum ether and 1 g of sodium sulfate decahydrate and mixing this mixture for 2 minutes at 300 rpm and room temperature; (iv) applying a vortex mixing for 30 seconds and; (v) centrifuging the mixture at 3000 rpm for 3 minutes and removing the petroleum ether phase; (vi) adding 3 ml of petroleum ether, centrifuging again at 3000 rpm for 3 minutes and removing the petroleum ether phase; (vii) repeating step (vi) until the yellow color of the samples disappears (6-8 time approximately); (vii) adding 1 of sodium sulfate anhydrous and mixing; (viii) evaporating to dry by using a rotatory evaporator; adding a known amount of ethanol to complete dissolution (1 to 5 mL) and (ix) determining the level of hydrolyzed (=total) astaxanthin in the sample by HPLC. The HPLC solvent system was (methanol/formic acid-water/formic acid) and the column was (Atlantis® HILIC Silica 5 μm 2,1×150 mm).

The results are reported in Table 5, wherein the retention of astaxanthin in digestive is expressed as relative bio-accessibility (in vitro model) based on the initial concentration of astaxanthin and considering the oleoresin as control.

TABLE 5
Astaxanthin retention in digestates

| | Examples | | | |
|---|---|---|---|---|
| | 5.1 | 4.5 | | |
| | (control) | (comparative) | 4.6 | 5.2 |
| Retention of astaxanthin in | 89 | 95 | 100 | 90 |
| post-stomach digestate (%) | | | | |
| Retention of astaxanthin in | 13 | 42 | 62 | 65 |
| post-intestine digestate (%) | | | | |
| Relative Bioaccessibility | | 3.2 | 4.8 | 5 |

As apparent from Table 5, astaxanthin is better protected against digestive conditions in both in vitro model stomach and in vitro model small intestine if a polar oat oil fraction is used in combination with Quillaja saponins as emulsifying system, compared to oleoresin alone or emulsified using a combination of Quillaja saponins and lecithins.

### Example 6

Example Vegetable Beverages:

### Preparation of Vegetable Beverages, According to the Present Invention

A series of emulsions vegetable beverages according to the present invention were obtained by performing, for each of them, the steps of:
1. Preparing an oil phase by mixing a kwon amount of coconut oil (A de coco, Coco Colima S.A. Mexico) and a known amount of polar oat oil fraction (PL 40, ex Swedish oat Fiber) (see Table 6) in a mixing vessel equipped with a magnetic stirrer hotplate (HYCC SH-2 Laboratory) operating at 1.000 rpm and 50° C., in order to obtain an oil phase;
2. Preparing a water phase by adding a known amount of Quillaja extract Sapnov Ls and a known amount of Potassium Bicarbonate in a known amount of water (see Table 6).
3. Mixing the oil phase and the water phase by using a SILVERSON Rotor-Stator mixer L5M, operating at 8.000 rpm for 2 minutes, in order to obtain a pre-emulsion.
4. Emulsifying the pre-emulsion by passing it one time through a two stage high-pressure homogenizer (APV 2000 Homogenizer Laboratory Model), operating at a second stage valve pressure from 20 to 30 bar and a first stage valve pressure from 100-300 bar, in order to obtain the final emulsion.
5. Pasteurizing the final emulsion through a water bath (Thermostatic water bath, Quimis) operating at 95° C. for 20 minutes.

In all examples, step 4 resulted in oil-in-water emulsions.

The volume-weighted mean D(4,3) of the oil droplet was measured by Static Light Scattering, using a Malvern Mastersizer 3000E. The emulsions were diluted with ultrapure water oil droplet size distribution was calculated using software implemented in the measurement instrument. The measurement was performed at room temperature.

TABLE 6
Composition and properties of final vegetable beverages emulsions containing
polar oat oil fraction PL 40 and Quillaja extract.

| | Ex.1 | Ex.2 | Ex.3 | Ex.4 | Ex.5 | Ex.6 |
|---|---|---|---|---|---|---|
| Coconut oil [wt.-%] | 4 | 4 | 4 | 4 | 4 | 4 |
| Quillaja extract (1) [wt.-%] | 0.50 | — | 0.17 | 1 | — | 0.30 |
| Oat oil PL 40 [wt.-%] | — | 0.50 | 0.33 | — | 1 | 0.70 |
| Potassium bicarbonate [wt.-%] | 0.05 | 0.01 | 0.025 | 0.05 | 0.01 | 0.025 |
| Water [wt.-%] | 95.49 | 95.49 | 95.49 | 94.99 | 94.99 | 94.99 |
| D 4.3 (μm)-Initial | 1.06 | 1.20 | 0.74 | 1.55 | 1.42 | 1.48 |
| D 4.3 (μm)-After 7 days | 1.12 | 1.39 | 0.83 | 0.98 | 1.22 | 0.91 |
| Ratio (D 4,3 initial/7 days) | 1.05 | 1.16 | 1.12 | 0.64 | 0.86 | 0.61 |

(1) Quillaja extract comprises 15 wt.-% Quillaja saponins

in Table 6 droplet sizes of emulsions prepared with quillaja, oat oil or a mix of both emulsifiers are shown fresh and after 7 days at room temperature. In Examples 1-3 an overall concentration of 0.5% has been applied. The sample 3 with the emulsifier mix shows the smallest D4,3 of all samples fresh. At 1% of emulsifier shows the highest D4,3 of all samples and the emulsifier combination leads to the lowest ratio.

A small droplet size is preferred as it will lead to a more stable beverage with less creaming. Also smaller droplets lead to a smoother mouthfeel.

At both emulsifier concentrations the droplet size after 7 days is also smallest for the emulsions prepared with the mixture of Quillaja and Oat oil.

It is also interesting to notice that only for the emulsifier combination the droplet size after 1 week is smaller for 0.5% than for 1%. This is an advantage as an overall lower emulsifier concentration will lead to lower cost and less off taste from the emulsifiers.

### Example 7. Creamer

### Preparation of Creamer, According to the Present Invention

A series of creamer emulsion according to the present invention were prepared by performing the steps of:
a). Preparing an oil phase by mixing a known amount (see Table 7) of coconut oil (A de coco, Coco Colima S.A. Mexico) and a known amount of polar oat oil fraction (PL 40, ex Swedish oat Fiber) in a vessel equipped with a magnetic stirrer hotplate operating at 500 rpm and 50° C. (HYCC SH-2 Laboratory), in order to obtain an oil phase;
b). Preparing a water phase by adding a known amount of Quillaja extract Sapnov Ls, a known amount of Potassium Bicarbonate, and a known amount of water (see Table 7),
c). Mixing the oil and the water phase under high shear, by using a SILVERSON Rotor-Stator mixer L5M, operating at 8.000 rpm for 2 minutes, in order to obtain a pre-emulsion;
d). Mixing pre-emulsion, sugar and salts under high shear by using a SILVERSON Rotor-Stator mixer L5M, operating at 2000 rpm for 1 minutes, in order to obtain the final pre-emulsion;
e). Emulsifying the pre-emulsion by passing one time through a two-stage high-pressure homogenizer (APV 2000 Homogenizer Laboratory Model), operating at a second stage valve pressure from 20 to 30 bar and a first stage valve pressure from 100-300 bar, in order to obtain the final emulsion.
f) Pasteurizing the final emulsion through a water bath (Thermostatic water bath, Quimis) operating at 95° C. for 20 minutes.

In all examples, step 4 resulted in oil-in-water emulsions.

The volume-weighted mean D(4,3) of the oil droplet was measured by Static Light Scattering, using a Malvern Mastersizer 3000E. The emulsions were diluted with ultrapure water, oil droplet size distribution was calculated using software implemented in the measurement instrument. The measurement was performed at room temperature.

TABLE 7
Composition and properties of final creamer emulsion
containing polar oat oil fraction PL 40 and Quillaja extract

| | Examples | | | | | |
|---|---|---|---|---|---|---|
| | Ex.1 | Ex.2 | Ex.3 | Ex.4 | Ex.5 | Ex.6 |
| Coconut oil [wt.-%] | 8 | 8 | 8 | 8 | 8 | 8 |
| Quillaja extract (1) [wt.-%] | 0.5 | — | 0.16 | 1 | — | 0.3 |
| Oat oil PL 40 [wt.-%] | | 0.5 | 0.34 | — | 1 | 0.7 |
| Potassium bicarbonate [wt.-%] | 0.01 | 0.01 | 0.01 | 0.01 | 0.01 | 0.01 |
| Sugar [wt.-%] | 24 | 24 | 24 | 24 | 24 | 24 |
| Salt [wt.-%] | 0.25 | 0.25 | 0.25 | 0.25 | 0.25 | 0.25 |
| Water [wt.-%] | 67.15 | 67.15 | 67.15 | 66.65 | 66.65 | 66.65 |
| D 4,3 (μm)-Initial | 0.99 | 4.64 | 1.41 | 0.94 | 3.24 | 0.91 |
| D 4,3 (μm)-after 7 days | 3.14 | 14.79 | 1.51 | 1.19 | 32.41 | 3.68 |
| Ratio (D 4,3 initial/7 days) | 3.16 | 3.19 | 1.07 | 1.27 | 10.01 | 4.07 |

The color parameters L*, a* and b* were measured by spectrocolorimeter, using a Konica Minolta CM5), 20 mL creamer emulsions were suspended in 180 ml, black coffee (1.5% of coffee). The measurement was performed at room temperature.

TABLE 8
Color parameter of creamer apply in coffee and black coffee

| | Examples | | |
|---|---|---|---|
| | L* | a* | b* |
| Ex. 4 | 36.7 | 9.5 | 30.2 |
| Ex. 5 | 36.5 | 9.8 | 31.2 |
| Ex. 6 | 36.2 | 10.2 | 32.3 |
| Coffee | 2.9 | 1.1 | 1.6 |

In Table 8 the D4,3 of the fresh emulsions as well as of emulsion aged for 7 days is shown. For the fresh emulsions the combination of oat oil and quillaja is leading to distinctly smaller droplets tan only oat oil. The droplet size with only quillaja is slightly smaller than the combination. However, after storing the emulsion for 7 days at room temperature it can be seen that the emulsifier combination leads to more stable emulsion with only very slightly increase od droplet size whereas the droplet size of the emulsions with only quillaja increase from 0.994 to 3.14 um. The simple with only oat oil is the most unstable.

When increasing the emulsifier concentration from a total of 0.5% to 1% the droplet size for the emulsions with only quillaja is not further decreased. The droplet size of the emulsions with oat oil is slightly decreased but still distinctly large. The droplet size of the emulsion with the emulsifer mix is slightly decreased to a value smaller than for only quillaja. The lower emulsifier concentration is preferred though to lower cost and lower off taste potentially resulting from the emulsifier. The ratio (D 4,3 initial/7 days) show that the optimal condition is 0.5% using a mix of natural emulsifier

The whitening effect of all coffee creamers on coffee (the fresh emulsion was applied) were comparable.

### Example 8

### Preparation of Ice Cream According to the Present Invention

A series of emulsions ice cream according to the present invention were obtained by performing, for each of them, the steps of
1. Preparing liquid by mixing a kwon amount of skimmed milk, corn syrup and a known amount Quillaja extract Sapnov Ls (see Table 9) in a mixing vessel and heat until 45° C., in order to obtain the liquid mixer;
2. Preparing the powder mixer by adding a known amount of skimmed milk powder, sugar and stabilizer (see Table 9);
3. Mixing the cream (35% of lipid) and a known amount of polar oat oil fraction (PL 40, ex Swedish oat Fiber) and heat to reach 45° C. in order to obtain a homogeneous mixer.
4. Mixing cream, liquid and powder mixer by using a SILVERSON Rotor-Stator mixer L5M, operating at 2.500 rpm for 10 minutes, in order to obtain all ingredient integrated;
5. Emulsifying the mixer by passing it one time through a two stage high-pressure homogenizer (APV 2000 Homogenizer Laboratory Model), operating at a second stage valve pressure at 20 and a first stage valve pressure at 175 bar, in order to obtain the final mixer;
6. Pasteurizing the final mixer through a water bath (Thermostatic water bath, Quimis) operating at 70° C. for 3 minutes;
7 Cooling the mixer below 5° C. for min 4 hour in order to provide the maturation step;
8 Overrunning the maturated mixture in the previously cooled ice machine

The overrun was measured by weight the mixer after maturation step and before the overrunning step and was expressed as percentage. The melting properties was measured by weighing a known amount of ice cream and it was placed on a 1 mm still mesh until 90% of the ice cream was melted at room temperature. The weight of the melted ice cream was recorded every 10 min and the plot of the percentage of melted ice cream versus time was plotted, slope of the linear part (time from 40 to 70 min) of the plot indicating melting rate (g/min).

TABLE 9
Composition and properties of ice cream containing
polar oat oil fraction Quillaja extract

| | Ex. 1 | Ex. 2 |
|---|---|---|
| Skimmed milk liquid [wt.-%] | 49.90 | 49.90 |
| Quillaja extract (1) [wt.-%] | | 0.34 |
| Oat oil PL 40 [wt.-%] | 0.50 | 0.16 |
| Stabilizer [wt.-%] | 0.20 | 0.20 |
| Cream 30% fat [wt.-%] | 28.30 | 28.30 |
| Sugar [wt.-%] | 12.00 | 12.00 |
| Corn syrup [wt.-%] | 5.00 | 5.00 |
| Skimmed milk powder | 4.10 | 4.10 |
| Melting rate (g/min) | 2.06 ± 0.14 | 2.13 ± 0.09 |
| Overrun (%) | 86.4 ± 2.14 | 88.0 ± 6.3 |

(1)Quillaja extract comprises 15 wt.-% Quillaja saponins

### Example 9

### Preparation of a Concentrate Containing CBD for Stable Beverages, According to the Present Invention

A series of emulsified concentrates according to the present invention were obtained by performing, for each of them, the steps of:
1. Mixing a known amount of Cannabidiol (CBD) rich oil with a known amount of vegetable oil (middle chain triglycerides (MCT) oil fraction, Miglyol 812, ex Oleo) and for example 2 and 3 a known amount of polar oat oil fraction (PL 40, ex Swedish oat Fiber) (see Table 10) in a mixing vessel equipped with a magnetic stirrer operating at 300 rpm, in order to obtain an oil phase;
2. For example 1 mixing a known amount of glycerin, of propylene glycol and of quillaja extract (see Table 10), in order to obtain a polar phase, in case of examples 2 and 3 the polar phase is only glycerin.
3 Sonicating the sample with a Hielscher UP200 Ht sonicator using a 14 mm tip at amplitude of 50% for 1 min.

In all examples, step 3 resulted in oil-in-water emulsions.

The Z-average size of the oil droplet was measured by Dynamic Light Scattering. The emulsions were diluted 1000 times with micro-filtered and degassed deionized water and immediately transferred to a Dynamic Laser Light Scattering measurement device Malvern Zetasizer Nano ZS90. The Z-average oil droplet size was then calculated using the software implemented in the measurement instrument. The measurement was performed at room temperature.

The turbidity of beverages flavored with the emulsified flavor concentrates were prepared by diluting the emulsified concentrates into drinkable water. For example 1 the emulsion was dosed at 2 g/kg and for sample 2 and 3 at 1 g/kg as the dosage of the CBD oil was higher in these emulsions. This corresponds to a concentration of 10 mg of CBD rich oil in the beverage.

Each of these beverages were transferred to a 95 mm×25 mm borosilicate glass photometric cell of and the turbidity was determined by measuring the light scattering intensity at a wavelength of 460-600 nm and an angle of 12° (forward scattering). The turbidimeter was a Hach 2100N Laboratory Turbidimeter. The turbidimeter was calibrated using Formazin standard suspensions and the result given in Nephelometric Turbidity Units (NTU).

The compositions of the concentrates, the Z-average size of the oil droplets during and after emulsification and the turbidity of the beverages obtained by diluting the emulsified concentrates are shown in Table 10.

TABLE 10
Composition and properties of emulsified CBD concentrates

| | Examples | | |
|---|---|---|---|
| | 1 | 2 | 3 |
| Cannabidiol (Hemppure 98% CBD) | 5 | | |
| Treehouse broad spec PDR 95% CBD | | 10 | 10 |
| MCT oil Miglyol 812 [wt.-%] | 1 | 2 | 2 |
| Oat oil PL 40 [wt.-%] | — | 10 | 5 |
| Quillaja extract (Sapnov L vegan) [wt.-%] | 8 | — | — |
| Propylene glycol | 2 | — | — |
| Glycerin [wt.-%] | 84 | 78 | 83 |
| Z-average particle-size [nm] | 172 | 99 | 122 |
| Emulsion stability after 1 month at 20° C. | stable | Stable | stable |

Example 2 and 3 show a distinctly smaller droplet size than comparative sample 1. This is important for the stability of the emulsion and the beverage. The smaller the droplets the slower the creaming rate of the droplets and hence ring formation. This is especially important as the concentrates shown here do not contain weighting agents and hence a prone to creaming.

Also smaller droplets are associated with better bioavailability than larger droplets.

### Example 10

Comparison of New Formulations Over Current Colour Emulsions, with Focus on Beverage Application

A new product range using a combination of Quillaja and oat oil as emulsifiers was formulated in order to investigate whether:
a) The product is stable
b) If it offers any advantage over existing colour emulsions in the art.

This experiment focuses on the comparison of product stability as-is and in beverage application of the new formulations versus existing emulsion products in the art.

Materials

Algal carotene—An opaque, deep red suspension of mixed carotenes in olive oil. The carotenes are obtained from the algae Dunaliella salina by physical extraction. Typically 30% Natural Beta-Carotene in Olive Oil.

Fungal carotene—A red, oily dispersion of beta-carotene from Blakeslea trispora extracted by solvent in sunflower oil. Typically 30 suspension of beta-carotene in sunflower oil.

Paprika—Dark red oily paste, solvent extracted from Capsicum annuum Linne fruits. Typically 195,000 Colour Units.

Lutein—Thick, dark yellow to brown paste, solvent extracted from Tagetes erecta flowers. Typically 10% Xanthophyll content.

Oat oil (PL 40, ex Swedish oat Fiber)

TABLE 11
Samples

| | | | Typical colour |
|---|---|---|---|
| Sample | | | strength E₁¹ in |
| Code | Pigment Source | Emulsifier(s) | acetone |
| QOO | Algal Carotene | Quillaja and Oat Oil | 23 |
| AC | | | |
| QOO P | Paprika | Quillaja and Oat Oil | 18.5 |
| QOO L | Lutein | Quillaja and Oat Oil | 14 |
| QOO | Fungal Carotene | Quillaja and Oat Oil | 33 |
| FC | | | |
| SP FC | Fungal Carotene | Sorbitan mono-oleate + | 23 |
| | | Polysorbate 80 | |
| SP AC | Algal Carotene | Sorbitan mong-oleate + | 23 |
| | | Polysorbate 80 | |
| SP L | Lutein | Sorbitan mono-oleate + | 10 |
| | | Polysorbate 80 | |
| GA AC | Algal Carotene | Gum Acacia | 23 |
| GA L | Lutein | Gum Acacia | 10 |
| GA P | Paprika | Gum Acacia | 15 |
| GA FC | Fungal Cartene | Gum Acacia | 23 |
| P P | Parika | Polysorbate 80 | 31.5 |

TABLE 12
Algal carotene formulation comparison

| | Sample Code | | |
|---|---|---|---|
| Ingredients % | QOO AC | SP AC | GA AC |
| Algal carotene | 3.4 | 3.32 | 3.35 |
| MCT oil | 6.6 | 24 | — |
| Sunflower oil | — | | 5.15 |
| Mixed tocopherols | 2 | — | — |
| Alpha tocopherol | — | 0.3 | 1.5 |
| Ascorbyl palmitate | — | 0.1 | — |
| Quillaja extract | 5 | — | — |
| Oat oil | 2.5 | — | — |
| Acacia gum | — | — | 15 |
| Polysorbate 80 | — | 6 | — |
| Sorbitate mono-oleate | — | 6 | — |
| DI water | 20 | 24 | 40 |
| Glycerine | 60.5 | 36.28 | 35 |

TABLE 13
Fungal carotene formulation comparison.

| | Sample Code | | |
|---|---|---|---|
| Ingredients % | QOO FC | SP FC | GA FC |
| Fungal carotene | 3.4 | 3.32 | 3.5 |
| MCT oil | 6.6 | 24 | — |
| Sunflower oil | — | — | 5 |
| Mixed tocopherols | 2 | — | 1.5 |
| Alpha tocopherol | — | 0.3 | — |
| Ascorbyl palmitate | — | 0.1 | — |
| Quillaja extract | 5 | — | — |
| Oat oil | 2.5 | — | — |
| Acacia gum | — | — | 15 |
| Polysorbate 80 | — | 6 | — |
| Sorbitan mono-oleate | — | 6 | — |
| DI water | 20 | 24 | 40 |
| Glycerine | 60.5 | 36.28 | 35 |

TABLE 14
Paprika formulation comparison

| | Sample Code | | |
|---|---|---|---|
| Ingredients % | QOO P | P P | GA P |
| Paprika extract | 6.5 | 20.84 | 5.2 |
| MCT oil | 3.5 | 10 | — |
| Sunflower oil | — | | 2.8 |
| Mixed tocopherols | 2 | — | 2 |
| Alpha tocopherol | — | 0.5 | — |
| Ascorbyl palmitate | — | 0.1 | — |
| Quillaja extract | 5 | — | — |
| Oat oil | 2.5 | — | — |
| Acacia gum | — | — | 15 |
| Polysorbate 80 | — | 68.56 | — |
| Sorbitan mono-oleate | — | — | — |
| DI water | 20 | — | 40 |
| Glycerine | 60.5 | — | 35 |

TABLE 15
Lutein formulation comparison.

| | Sample Code | | |
|---|---|---|---|
| Ingredients % | QOO L | SP L | GA L |
| Lutein extract | 4.67 | 3.333 | 3.33 |
| MCT oil | 5.33 | 20 | 4.67 |
| Sunflower oil | — | | — |
| Mixed tocopherols | 2 | — | 2 |
| Alpha tocopherol | — | 0.3 | — |
| Ascorbyl palmitate | — | 0.1 | — |
| Quillaja extract | 5 | — | — |
| Oat oil | 2.5 | — | — |
| Acacia gum | — | — | 18 |
| Polysorbate 80 | — | 2.5 | — |
| Sorbitan mono-oleate | — | 2.5 | — |
| DI water | 20 | 24 | 40 |
| Glycerine | 60.5 | 47.267 | 32 |

Methods

The dosages of colour into lemonade have been determined pro-rata based on typical E| of each product and compared to the relevant quillaja and oat oil based emulsion (QOO x) at 0.1%.

250 ml transparent PET bottles were used and a volume of 200 ml total beverage was made for each sample.

Lemonade=Morrisons (supermarket) Lemonade. See ingredient list below:

Carbonated water, Sugar, Acid (Citric acid), Flavouring. Acidity Regulator (sodium citrates),

Preservative (potassium sorbate), Sweeteners (acesulfame K, sucralose).

Memmert Oven—Model UN 30 digitally set to 40° C.

Advantage 1—Better Instant Solubility and Less Foaming in Beverage Vs High Polysorbate Based Emulsions

The emulsions based on polysorbate 80 have a relative good clarity. However formulations with high polysorbate levels have decreased ‘instant’ dispensability in application, especially cold beverage bases, and can generate foam during the mixing step.

QOO P quillaja with oat oil based emulsion paprika does not have these negative implications in beverage application.

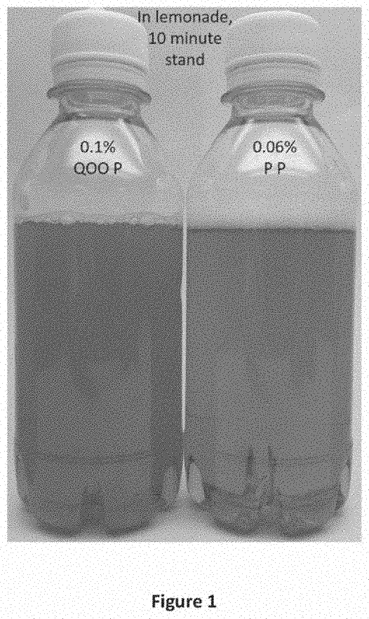

See FIG. 1 for an example of foam layer in lemonade from P P (high polysorbate based emulsion) vs QOO P (Quillaja and oat oil based emulsion) after the samples had been left overnight to dissolve, inverted 10 times then left to stand for 10 minutes.

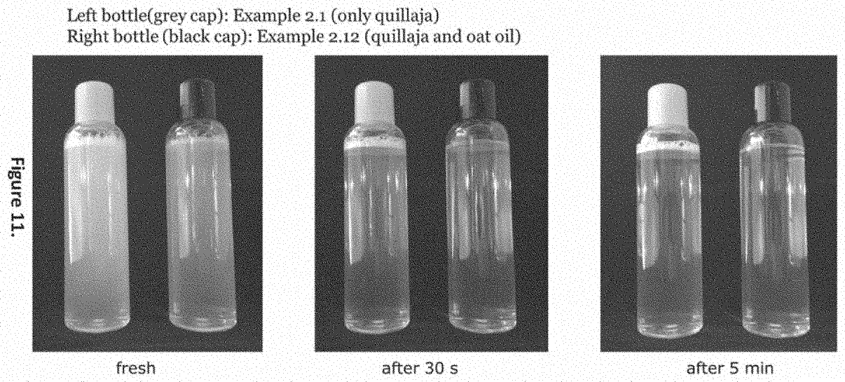

See FIG. 11 for an example of foam layer in a quillaja emulsion versus an emulsion of the invention with quillaja and oat oil. The emulsion of the invention after 30 seconds or 5 minutes does not present foam while the emulsion with quillaja has foam even after 5 minutes.

Advantage 2—Increased Stability of the Liquid Emulsion at Higher Storage Temperatures Vs Polysorbate & Sorbitan Monoleate Emulsions, Demonstrated Using 40° C. Storage

The most common beverage stable colour emulsions to recommend for acceptable clarity and stability in acid conditions in the prior art would be emulsions using a combination of polysorbate and sorbitan mono-oleate emulsifiers.

Using dual emulsifiers means the amount of polysorbate 80 can be reduced and the ‘instant’ solubility and foaming issues are reduced.

As the natural colour market is ever expanding across the globe it is often the case that colour emulsions may be shipped at ‘ambient’ temperature for several weeks to reach their destination. Also companies using the colour in their foodstuffs do not always have chilled storage and request for ambient storage for colour products.

Therefore an elevated temperature storage trial was performed in a dark condition oven set to 40° C. (Memmert UN30).

The liquid emulsions were measured on a Malvern Mastersizer 3000 using laser diffraction every week for up to 3 months to evaluate shift in particle size. Below are shown the particle size graphs (colour) and for publications where colour figures are not suitable they have been represented instead by the Dx(10) μm, Dx(50) μm and Dx(90) μm values, explained below.

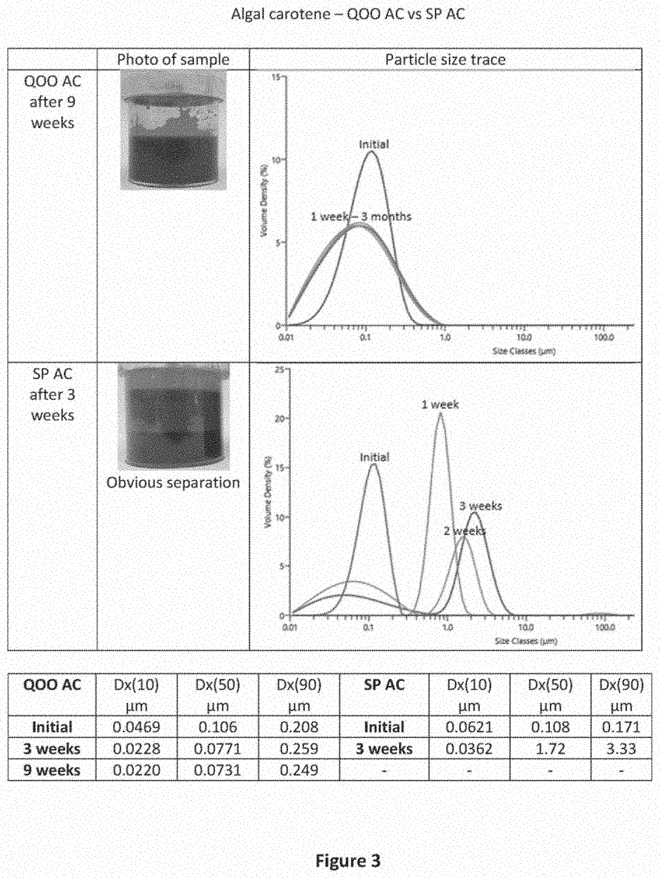

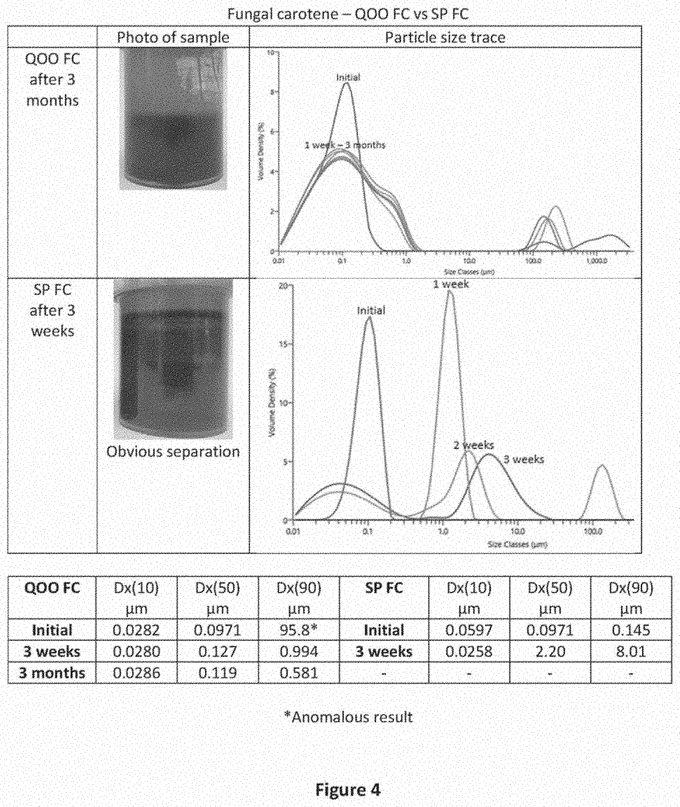

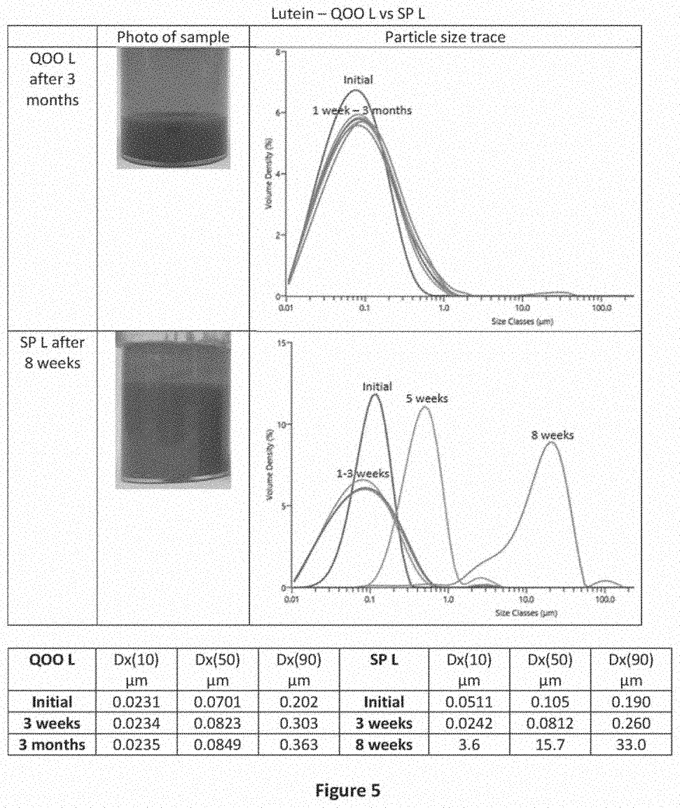

We can see in all cases (FIGS. 3, 4 and 5) that with the quillaja and oat oil emulsions there is an initial shift in particle size after 1 week but then the emulsion stabilizes and gives repeatable results over the following weeks.

However the polysorbate and sorbitan mono-oleate emulsions show a continuous degradation of the emulsion over time to the point where it becomes a complete phase separation in some cases as shown in the photos.

Advantage 3—Improved Clarity and Stability in Beverage Vs Gum Acacia Based Emulsions

The polysorbate-free emulsions that can generally tolerate acidic conditions are based on acacia gum. However not all acacia gum emulsions are stable in beverage and ‘ringing’ can occur, where released oils can collect on the surface of the beverage when the emulsion deteriorates.

The particle size of the droplets in these emulsions is larger than the quillaja and oat oil emulsions, meaning the appearance in beverage is more opaque.

As stated in the ‘methods’ section, the quillaja and oat oil based emulsions QOOx were dosed into lemonade at 0.1%, the gum acacia based emulsions were pro-rata calculated based on middle of E| specification and dosed into lemonade also.

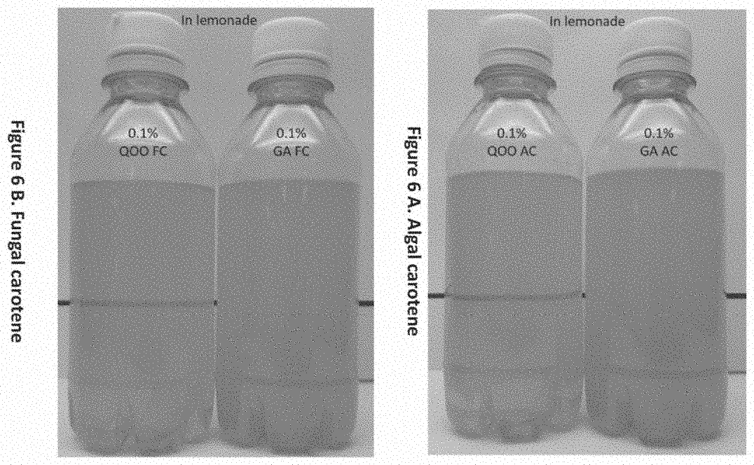

A photo was taken with a black line drawn on a piece of white paper behind the bottles to demonstrate the difference in opacity, the line can be clearly seen behind the quillaja with oat oil emulsions but cannot be seen through the acacia gum emulsions (FIGS. 6A, B, C and D).

To give a numerical value to the haze, each of the samples were measured using a CM-3600A Konica Minolta spectrophotometer according to ASTM method D1003. The higher the number the more opaque the sample

TABLE 16
Haze value

| Reference | Haze value | Reference | Haze value |
|---|---|---|---|
| QOO AC | 17.39 | GA AC | 61.89 |
| QOO P | 13.54 | GA P | 94.53 |
| QOO L | 10.49 | GA L | 65.38 |
| QOO FC | 24.76 | GA FC | 56 76 |

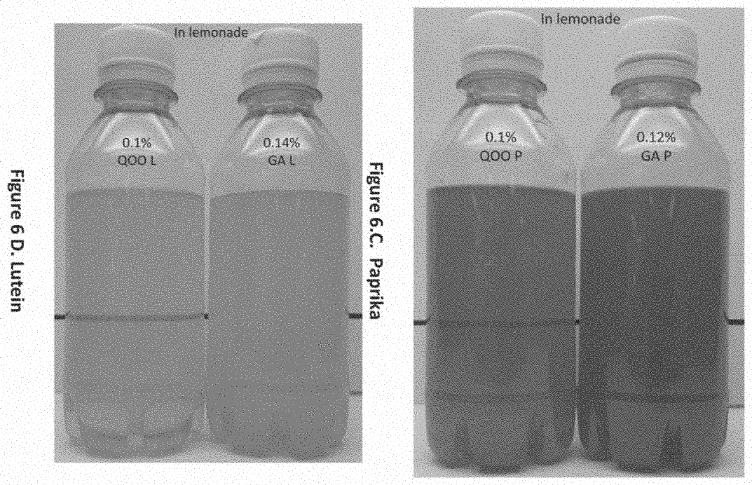

For ringing evaluation the beverage samples were stood on a shelf at room temperature until ring formation was visible then a photo was taken (see FIG. 7).

### Example 12

### Preparation of Margarine, According to the Present Invention

A series of margarine emulsions according to the present invention were prepared by performing the steps of:
1. Dissolving a known amount of the emulsifier and beta-carotene into palm oil at 65° C. with a magnetic stirrer.
2. Melting palm oil and rapeseed oil in separate beakers until the temperatures reaches 50° C. in a microwave. Blending the oils in a known ratio with a Thermomix® Adding the emulsifier mix and blending.
3. Dissolving a known amount of lactic acid, potassium sorbate and salt into the water and heat to 50° C.
4. Adding solution from step 3 dropwise into the oil mixture in a Thermomix® and blending for 5 minutes (800 rpm)
5. Adding the whole quantity into the bowl of a Stephan mixer.
6. Blending the mix in the Stephan mixer (30%-900 rpm) for 15 minutes under vacuum, while cooling down the temperature of the product until 15° C.

TABLE 17
Margarines

| Ingredients | Control (%) | Recipe 2 (%) | Recipe 3 (%) |
|---|---|---|---|
| Palm oil RBD | 50 | 50 | 50 |
| Rapeseed oil RBD | 30.38 | 28.28 | 28.31 |
| Distilled water | 19 | 19 | 19 |
| E270 lactic acid | 0.04 | 0.04 | 0.04 |
| E202 potassium | 0.05 | 0.05 | 0.05 |
| sorbate | | | |
| E160a(ii) beta | 0.03 | 0.03 | 0 |
| carotenes | | | |
| Salt | 0.1 | 0.1 | 0.1 |
| E471 mono and | 0.4 | 0 | 0 |
| diglycerides of fatty | | | |
| acids | | | |
| SWEOAT oil PL15 | 0 | 2.5 | 2 |
| Sapnov LS | 0 | 0 | 0.5 |

TABLE 18
Evaluation of the margarines.

| | | | Microscopic |
|---|---|---|---|
| sample | Spreading texture | Taste | evaluation |
| Control | melt very quickly, | Melt very quickly | Non-homogeneous |
| | grainy, with fat | in mouth, aqueous, | droplets size, |
| | spots (bad | very liquid, piquant | presence of oily |
| | emulsion) | | droplets, size 6 to |
| | | | 77 um |
| recipe 2 | a bit grainy, | Melt quickly in | Fine, homogeneous |
| (oat oil) | harder than | mouth, oily notes, | particle, but single |
| | control, streaked | strong smell | oil droplets up to |
| | when spread. | | 120 um visible |
| recipe 3 | less hard and | Melt quickly in | Good dispersion, |
| (oat oil + | grainy than | mouth, less oily | fine, homogeneous |
| quillaja) | recipe 2 | notes than recipe 2 | droplets |
| | | | Droplet size |
| | | | between 2.5 μm |
| | | | and 7.5 μm |

With the chosen process the best results could be achieved with a combination of oat oil and quillaja. The reference with mono and diglycerides of fatty acids was more difficult to prepare than the examples with oat oil and oat oil and quillaja. Quillaja alone was not used as emulsifier as it is an oil-in-water emulsifier that is not suited to prepare water-in-oil emulsions such as margarine. The addition however, of a small amount of quillaja to the emulsifier oat oil led to a reduction of the droplet size and hence a more smooth and stable product. In addition the reduction of the amount of oat oil led to reduction of off taste coming from oat oil.

### Example 13

### Preparation of Omega-3 Fatty Acid Emulsion According to the Present Invention

A series of margarine emulsions according to the present invention were prepared by performing the steps of:
1. Dissolving a known amount of the fish oil (30% omega 3-SPES S.A), a known amount of MCT (medium-chain triglycerides MCT oil 60/40, comprising mainly caprylic acid and capric acid, Ex Oleon) into polar oat oil fraction (PL 40, ex Swedish oat Fiber) at 50° C. with a magnetic stirrer, whit or without a known amount of mixed tocopherols (70% of total tocopherols, Xi'an Healthful Biotechnology Co., Ltd).
2. Dissolving a known amount of Quillaja extract and glycerin into the water and heat to 50° C. in order to obtain the water phase.
3. Adding the oil from step 1 into the water phase and mixing using a Laboratory Mixer (Silverson®-L5M-A, USA) for 3 min at 9000 rpm.
4. Cooling the concentrates obtained in step 3) in an ice bath to room temperature while reducing the stirring speed to 7000 rpm, and stirring for 5 minutes;
5. Emulsifying the mixer from step 4 by passing two time through a two-stage high-pressure homogenizer (APV 2000 Homogenizer Laboratory Model), operating at a second stage valve pressure from 70 bar and a first stage valve pressure from 700 bar, in order to obtain the final emulsion.

TABLE 20
Examples of omega 3-containing natural emulsified
with mean droplet size and peroxide values

| | Ex. | Ex. | Ex. | Ex. | Ex. | Ex |
|---|---|---|---|---|---|---|
| Ingredients (wt %) | 13.1 | 13.2 | 13.3 | 13.4 | 13.5 | 13.6 |
| Destilled water | 22 | 22 | 22 | 20.5 | 20.5 | 20.5 |
| Quillaja extract | 4.7 | | 7 | 4.7 | | 7 |
| (QQ000005) | | | | | | |
| Oat oil (PL40) | 2.3 | 7 | | 2.3 | 7 | |
| Glycerin | 61 | 61 | 61 | 61 | 61 | 61 |
| Omega-3 (30%) | 3.4 | 3.4 | 3.4 | 3.4 | 3.4 | 3.4 |
| MCT | 6.6 | 6.6 | 6.6 | 6.6 | 6.6 | 6.6 |
| Tocopherol | | | | 1.5 | 1.5 | 1.5 |
| Droplet size-D(4,3)-initial (nm) | 131.0 | 150.3 | 118.2 | 124.4 | 136.0 | 140.4 |
| Droplet size-D(4,3)-after | 172.2 | 171.5 | 129.1 | 132.3 | 144.4 | 151.1 |
| 50 days (nm) | | | | | | |
| Peroxide value (meq/kg of | 0.99 | 2.77 | 1.98 | 3.52 | 6.39 | 3.39 |
| sample)-after 60 days | | | | | | |
| storage at 40° C. | | | | | | |

The volume-weighted mean D(4,3) of the oil droplet was measured by Dynamic Light Scattering, using a Nicomp PSS, Model Z3000 Dynamic Laser Light Scattering measurement instrument. The intensity-weighted droplet size distribution was converted to volume-weighted droplet size distribution by using the software implemented in the instrument. All the emulsions were diluted 250 times with micro-filtered and degassed deionized water before measurement.

TBARS and hydroperoxides were determined by spectrophotometric methods described in literature. The peroxide value of each sample was determined using the AOCS official method (methodCd8b-90)(AOCS, 1998).

Discussion:

The oxidative stability of lipids in the emulsion was evaluated using different techniques for measuring oxidation. The peroxide values describe the main initial products of lipid oxidation while the thiobarbituric acid reactive substances (TBARS) is the common methods to measure lipid peroxidation end product malonaldehyde.

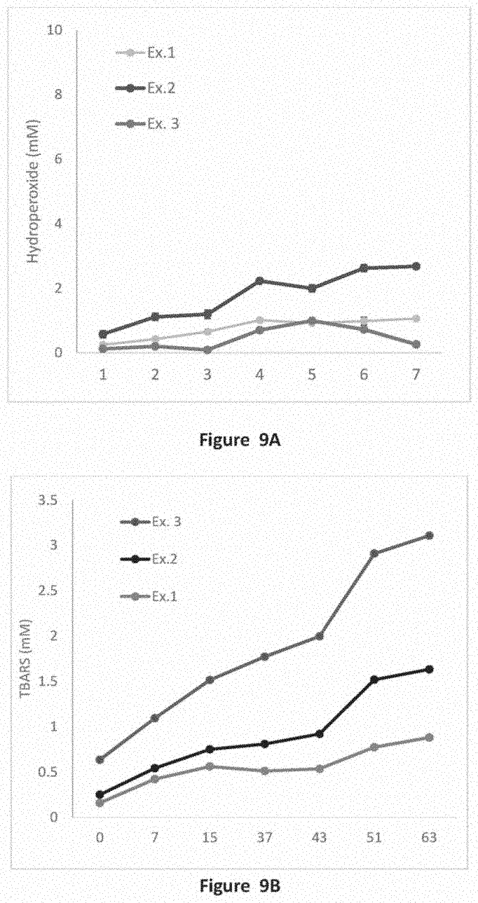

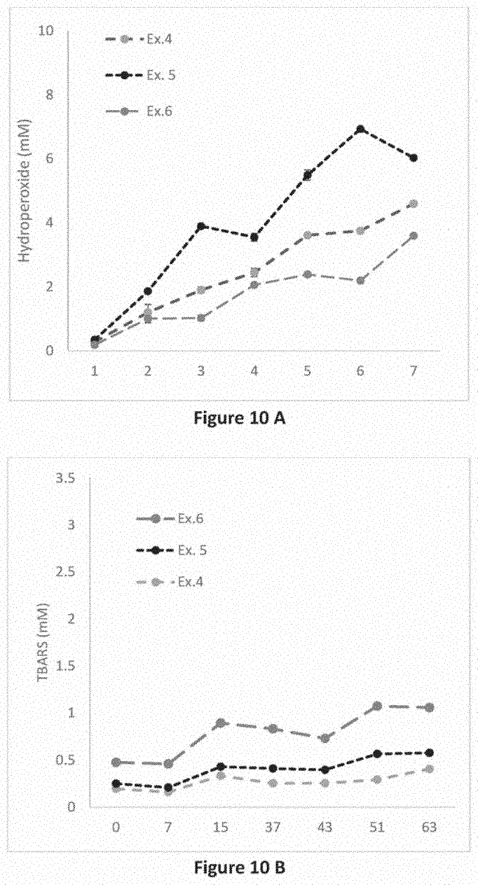

The peroxide values measured in the oil extracted from the omega 3 emulsion is correlated with hydroperoxide measures. The highest values of TBARS show the most unstable emulsion against oxidation. FIGS. 9 and 10 show that samples prepared using only Quillaja as emulsifier and without tocopherol were the most unstable followed by PL40 and finally, by the combination of emulsifiers. The same behavior was observed in those samples that were prepared with tocopherol, however the level of the oxidation was lower than the samples without tocopherol. Lipid oxidation is generally catalyzed by trace metals and this could be related with the high values observed in the Ex. 3 and 6 because the iron and copper content present in the Quillaja extract were 16.17 and 3.8 ppm, respectively. However, the PL40 showed lower values of iron (<0.1 ppm) but higher values of copper (29.75 ppm) in comparison with Quillaja extract, which is related with the oxidation values. The best results could be achieved with a combination of oat oil and Quillaja to avoid the oxidation of omega-3 fatty acids.

This result is not only relevant for the encapsulation of omega-3 fatty acids but also other food applications containing flavours or colours benefit from an increased stability to oxidation.

TABLE 20
Lipid composition of PL40 and PL15 Oat oils.
LIPID CLASS COMPOSITION (% total lipid) OF OILS

| | SAMPLE ID | | | |
|---|---|---|---|---|
| | 5073 | 5074 | 5075 | 5076 |
| | Dec. 16, 2016 | Dec. 16, 2016 | Dec. 16, 2016 | Dec. 16, 2016 |
| | PL40-FG | PL40-FG | PL40-FG | PL15 |
| LIPID CLASS | 40FG-160516 | 40FG-210915 | 40FG-100615 | 15FO-250915 |
| Wax/Sterol esters | <LOQ | <LOQ | <LOQ | <LOQ |
| Triacylglycerols | 37.0 | 33.4 | 32.5 | 44.4 |
| Free fatty acids | 11.4 | 8.8 | 8.3 | 8.4 |
| Cholesterol/sterols | 9.5 | 7.7 | 7.7 | 11.8 |
| Unknown neutral lipid¶ | 2.1 | 2.6 | 2.5 | 4.2 |
| Total neutral lipids | 60.0 | 52.5 | 51.0 | 68.8 |
| Monogalactosyldiacyiglycerols | 2.4 | 3.0 | 3.5 | 2.4 |
| Unknown glycolipid* | 6.3 | 9.5 | 8.1 | 4.8 |
| Ceramides | 4.0 | 4.4 | 6.0 | 4 0 |
| Digalactosyldiacylglycerols | 7.2 | 8.2 | 8.6 | 4.9 |
| Unknown polar lipid# | 0.6 | 0.8 | 1.6 | 1.5 |
| Phosphatidylethanolamine | 2.9 | 3.9 | 4.0 | 2.6 |
| Phosphatidic acid/ | | | | |
| Phosphatidylglycerol/ | 1.2 | 1.1 | 1.3 | 0.9 |
| cardiolipin | | | | |
| Phosphatidylinositol | 3.6 | 4.6 | 4.1 | 0 8 |
| Phosphatidylserine | 0.8 | 1.1 | 0.7 | 1.9 |
| Phosphatidylcholine | 6.0 | 6.0 | 6.5 | 3.6 |
| Sphingomyelin | <LOQ | <LOQ | <LOQ | <LOQ |
| Lysophosphatidylcholine | 1.0 | 1.0 | 1.1 | 0.5 |
| Pigmented material | 4.0 | 3.9 | 3.5 | 2.7 |
| Total polar lipids | 40.0 | 47.5 | 49.0 | 31.2 |

#Possibly Sulfolipid
*May contain traces of ceramides
¶Possibly diacylglycerol
Above values calculated from analyses performed in duplicate, as determined by HPTLC

1. An emulsion comprising:
a. oat oil, comprising 8 wt.-% or more of ceramides and glycolipids;
b. optionally at least one polyol and/or a native or modified carbohydrate; and
c. optionally at least one benefit agent.

2. The emulsion according to claim 1, further comprising at least one saponin.

3. The emulsion according to claim 1, wherein the emulsion is selected from the group consisting of a water-in-oil emulsion and an oil-in-water emulsion.

4. The emulsion according to claim 1, further comprising water in an amount selected from the group consisting of 80 wt. % or less, 70 wt. % or less, 20 wt. % or less, or 10 wt. % or less.

5. The emulsion according to claim 1, wherein the mean droplet diameter of dispersed droplets in the emulsion is from 50 nm to about 20 micrometer.

6. The emulsion according to claim 1 prepared by a process comprising:
a) mixing ingredients of an aqueous phase;
b) mixing ingredients of a lipid phase;
c) dispersing the oat oil and optionally at least one saponin in at least one of the aqueous phase or the lipid phase; and
d) homogenizing the aqueous and lipid phases to form an emulsion.

7. A concentrate comprising:
a) oat oil, comprising 8 wt.-% or more of ceramides and glycolipids;
b) at least one polyol and/or a native or modified carbohydrate; and
c) at least one benefit agent.

8. The concentrate according to claim 7, wherein:
i) the concentration of oat oil in the concentrate is from 0.5 to 25 wt.-%;
ii) the concentration of polyol and/or native or modified carbohydrate in the concentrate is from 5 wt.-% to 85 wt.-%; and
iii) the concentration of the at least one benefit agent in the concentrate is from 0.01 wt.-% to 40 wt.-% based on the total weight of the concentrate.

9. The concentrate according to claim 7, further comprising at least one saponin.

10. The emulsion according to claim 2, wherein the at least one saponin is selected from the group consisting of quillaja saponins, tea saponins, licorice saponins, beet root saponins, fenugreek saponin, alfalfa saponin, fennel saponin, garlic saponin, asparagus saponin, quinoa saponin, sugar beet saponins, ginseng saponins, glycyrrhizin, oat bran saponins, yucca saponins, and mixtures thereof.

11. The emulsion according to claim 2, wherein the saponin concentration is from 0.05 wt.-% to 20 wt.-%.

12. The emulsion according to claim 1, wherein the oat oil are polar lipids in an amount selected from the group consisting of at least 10%, at least 11%, at least 12%, at least 13%, at least 14%, at least 15%, at least 16%, at least 17%, at least 18%, at least 19%, at least 20%, at least 22%, at least 23%, at least 24%, at least 25%, at least 26%, at least 27%, at least 28%, at least 29%, at least 30%, at least 31%, at least 33%, at least 35%, or at least 40% by weight of the oat oil are polar lipids.

13. (canceled)

14. (canceled)

15. (canceled)

16. The concentrate according to claim 7 which is in the form of an emulsified concentrate comprising droplets of a dispersed phase and a continuous phase, and wherein the dispersed phase comprises oil-soluble components of the emulsion and the continuous phase comprises oil-insoluble components of the emulsion.

17. A method to obtain the concentrate according to claim 7, the method comprising the steps of:
a. mixing the oat oil, the at least one benefit agent and optionally a vegetable oil product, to form an oil phase mixture;
b. adding the oil phase mixture to the at least one polyol and/or a native or modified carbohydrate, to form a polar phase;
c. optionally adding at least one saponin and/or water; and
d. mixing all ingredients to obtain a concentrate.

18. (canceled)

19. A combination comprising at least one oat oil and at least one saponin for stabilized emulsions.

20. A method of using the combination according to claim 19 as an emulsifying agent.

21. A product comprising a food or beverage product for humans or animals, a nutritional supplement, a nutraceutical formulation, a fragrance or flavouring, a pharmaceutical or veterinary formulation, or an oenological or cosmetic formulation comprising an emulsion according to claim 1.

22. The product according to claim 21, wherein the emulsion comprises from 0.001% to about 0.04 wt.-% of the at least one benefit agent, based on the total weight of the product.

23. The product according to claim 21 having a turbidity selected from the group consisting of from 300 to 500 NTU, less than 35 NTU, less than 30 NTU, less than 20 NTU, or less than 10 NTU, or a haze value selected from the group consisting of less than 25%, less than 20%, less than 15%, or less than 10%.

24. (canceled)

25. A method of using the emulsion according to claim 1 to obtain a food or beverage product, a nutritional supplement, a nutraceutical formulation, a fragrance or flavouring, a pharmaceutical or veterinary formulation, or an oenological or cosmetic formulation having a turbidity selected from the group consisting of less than 35 NTU, less than 30 NTU, still more particularly less than 20 NTU, or less than 10 NTU, or a haze value selected from the group consisting of less than 25%, less than 20%, less than 15%, or less than 10%; or is a cloudy food and beverage product having a turbidity from 300 to 500 NTU.

26. A beverage comprising from 0.01 to 10 wt-% of the concentrate according to claim 7, wherein the concentrate comprises:
a. from 0.5 to 25 wt.-% of the oat oil comprising at least 8 wt. % of ceramides and glycolipids;
b. from 5 wt.-% to 85 wt.-% of at least one polyol, and/or native or modified carbohydrate;
c. from 0.1 wt.-% to 40 wt.-% of the at least one benefit agent, based on the total weight of the concentrate;
wherein the concentrate further comprises:
d. from 0 to 7 wt.-% of at least one saponin;
e. from 0 to 40 wt.-% of a vegetable oil product; and
f. 20 wt.-% or less of water.

27. A method of using the emulsion according to claim 1 to increase at least one of bioaccessibility, bioavailability, bioefficacy and bioactivity of an active or benefit agent or to prevent oxidation of an active or benefit agent.

28. (canceled)

29. The concentrate according to claim 9, wherein the saponin concentration is from 0.05 wt. % to 20 wt. %.

30. A method of using the emulsified concentrate according to claim 16 to obtain a food or beverage product, a nutritional supplement, a nutraceutical formulation, a fragrance or flavouring, a pharmaceutical or veterinary formulation, or an oenological or cosmetic formulation having a turbidity selected from the group consisting of less than 35 NTU, less than 30 NTU, less than 20 NTU, or less than 10 NTU, or a haze value selected from the group consisting of less than 25%, less than 20%, less than 15%, or less than 10%; or is a cloudy food and beverage product having a turbidity of from 300 to 500 NTU.

31. A method of using the emulsified concentrate according to claim 16 to increase at least one of bioaccessibility, bioavailability, bioefficacy, and bioactivity of an active or benefit agent or to prevent oxidation of an active or benefit agent.

32. A product comprising a food or beverage product for humans or animals, a nutritional supplement, a nutraceutical formulation, a fragrance or flavouring, a pharmaceutical or veterinary formulation, or an oenological or cosmetic formulation comprising the emulsified concentrate according to claim 16.

33. The product according to claim 32 having a turbidity selected from the group consisting of from 300 to 500 NTU, less than 35 NTU, less than 30 NTU, less than 20 NTU, less than 10 NTU, or a haze value selected from the group consisting of less than 25%, less than 20%, less than 15%, or less than 10%.
